(19) United States
(12) Patent Application Publication
(10) Pub. No.: US 2026/0120078 A1
(43) Pub. Date: Apr. 30, 2026

(54) ACCESS CONTROL BY CONTACTLESS SMART CARD

(71) Applicant: Capital One Services, LLC, McLean, VA (US)

(72) Inventors: Kevin Osborn, Newton, MA (US); Srinivasa Chigurupati, McLean, VA (US); David Kelly Wurmfeld, McLean, VA (US)

(73) Assignee: Capital One Services, LLC, McLean, VA (US)

(21) Appl. No.: 18/925,720

(22) Filed: Oct. 24, 2024

(51) Int. Cl. G06Q 20/34; G06Q 20/40

(52) U.S. Cl. CPC G06Q 20/352; G06Q 20/4015

(57) ABSTRACT

Disclosed herein are embodiments for altering a state of an access control system using a contactless smart card. The contactless smart card is tapped to a mobile device and the mobile device receives an authentication code from the contactless smart card. The authentication code is verified and the geographic location of the mobile device is determined. If the geographic location of the mobile device is within a predefined distance of the access control system and the authentication code is verified, a user associated with the contactless smart card and the mobile device is allowed to alter a state of the access control system. Altering the state of the access control system involves sending a control signal thereto to alter the state of the access control system.

### BACKGROUND

Contactless card products have become so universally well-known and ubiquitous that they have fundamentally changed the manner in which financial transactions and dealings are viewed and conducted in society today. Contactless card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with contactless cards constitute an increasingly large share of commercial activity.

Physical security has also grown as a concern as businesses and individuals and families alike desire to keep their businesses and homes safe from intruders or unauthorized visitors. Typically, physical security is provided by electronic locking systems and entrants are provided with physical keys or fobs to gain access. However, physical keys and fobs can be cumbersome and the probability that someone can steal the key and use the key or fob to maliciously gain access is potentially high.

Accordingly, there is a need to provide businesses and users with an appropriate solution that overcomes current deficiencies to provide data security, authentication, and verification for a contactless card.

### BRIEF SUMMARY

One general aspect includes a method to provide access to an access control system or to alter a state of the access control system. The method includes receiving, by an application executing on a processor circuit of a mobile device, encrypted data from a communications interface of a contactless card associated with a user account. The method further includes determining, based on the encrypted data, whether the user account is authorized to alter a state of an access control system. The method further includes determining, by the mobile device, a geographic location thereof. The method also includes, in response to the user account being authorized to alter the state of the access control system and the geographic location of the mobile device being located within a predefined distance of the access control system, causing a control signal to be transmitted to the access control system to thereby alter the state of the access control system. Other embodiments of this aspect include corresponding computer systems, apparatus, and computer programs recorded on one or more computer storage devices, each configured to perform the actions of the methods.

One general aspect includes an apparatus comprising memory to store instructions thereon and a processor circuit to execute the instructions. In response to executing the instructions, the processor circuit is caused to receive an authentication code from a communications interface of a contactless card associated with a user account, the user account also being associated with a computer application executing on the apparatus. The processor circuit is further caused to determine, based on the authentication code, whether the user account is authorized to alter a state of an access control system. The processor circuit is further caused to determine a geographic location of the apparatus. The processor circuit is further caused, in response to the user account being authorized to alter the state of the access control system and the geographic location of the apparatus being located within a predefined distance of the access control system, to cause a control signal to be transmitted to the access control system to thereby alter the state of the access control system. Other embodiments of this aspect include corresponding computer systems, apparatus, and computer programs recorded on one or more computer storage devices, each configured to perform the actions of the methods.

One general aspect includes non-transitory computer-readable storage medium having computer-readable instructions embodied therewith, the computer-readable instructions executable by a processor circuit to cause the processor circuit to receive encrypted data from a communications interface of a contactless card associated with a user account. The processor circuit is further caused to determine, based on the encrypted data, whether the user account is authorized to alter a state of an access control system. The processor circuit is further caused to determine a geographic location thereof, and in response to the user account being authorized to alter the state of the access control system and the geographic location of the mobile device being located within a predefined distance of the access control system, to cause a control signal to be transmitted to the access control system to thereby alter the state of the access control system. Other embodiments of this aspect include corresponding computer systems, apparatus, and computer programs recorded on one or more computer storage devices, each configured to perform the actions of the methods.

Non-transitory computer program products (i.e., physically embodied computer program products) are also described that store instructions, which, when executed by one or more data processors (i.e., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

FIG. 1 illustrates a block diagram of various network components in accordance with one embodiment.

FIG. 2A illustrates a contactless card in accordance with one embodiment.

FIG. 2B illustrates a transaction card component in accordance with one embodiment.

FIG. 3 illustrates a block diagram of an example mobile device of the subject matter in accordance with one embodiment.

FIG. 4 illustrates a block diagram of an example access control system in accordance with one embodiment.

FIG. 5 illustrates a network diagram in accordance with one embodiment.

FIG. 6 illustrates a method of access control in accordance with one embodiment.

FIG. 7 illustrates a sequence flow in accordance with one embodiment.

FIG. 8 is a network diagram of a routing network to operate in accordance with embodiments discussed herein.

FIG. 9A is a flow diagram illustrating operations performed in accordance with one embodiment.

FIG. 9B is a flow diagram illustrating operations performed in accordance with one embodiment.

FIG. 9C is a flow diagram illustrating operations performed in accordance with one embodiment.

FIG. 10 is a message diagram indicating a message format in accordance with one embodiment.

FIG. 11 is a diagram of a key system according to an example embodiment.

FIG. 12 illustrates a routine in accordance with one embodiment.

FIG. 13 is a network diagram of a distributed network in accordance with one embodiment.

FIG. 14 is a flow diagram in accordance with one embodiment.

### DETAILED DESCRIPTION

Other uses, beyond commercial transactions, are contemplated for contactless card products. For example, some access control systems may need to verify a user attempting to access the system. Existing methods of verifying that a user is authorized to access various access control systems, such as doors, lockers, etc., involve a user entering a passcode, scanning a code from their phone, or a sensor (e.g., camera, biometric, fingerprint sensor, etc.), being used to verify the identity of the user attempting to access the system. However, these methods involve the user remembering a passcode or the use of sensors or barcode readers, etc., that can be damaged, malfunction easily (e.g., due to bad weather), or otherwise introduce issues preventing the user from accessing the system, even though they may be authorized to access the system. As such, it might be advantageous for the user to be able to access or otherwise alter the state of an access control system using their contactless card for authentication.

Described herein are embodiments of a method and system for providing access control by contactless smart card. In some embodiments, a user having a user account associated with the contactless card may have a mobile device having one or more applications executing thereon. For example, the mobile device may have an application associated with an issuer of the contactless card and an application associated with an access control system that the user wishes to access. The access control system may be any suitable system or control system that the user wishes to activate or access. For example, the access control system may include a door with a network-connected locking mechanism or a garage door system with a network-connected controller. The access control system may also be, for example, a smart locker with network-connected control system or any other suitable system. Instead of using a passcode that the user would need to remember or that would require a keypad, or instead of using a radio frequency identification (RFID) reader, biometric, ocular, or any other sensor, embodiments of the present disclosure utilize the security and authentication provided by the contactless card and a mobile device of the user to access or control the access control system described herein. As described below, the contactless card provides an authentication, authorization code, or encrypted data to the mobile device of the user and the authentication code (also referred to herein as encrypted data) is verified and then access to the access control system is granted to the user, or the user is allowed to alter a state of the access control system, such as unlocking a locked door, activating a controller of a garage door to open the garage door, etc.

The systems and methods described here may enable users to perform these functions in a multi-issuer environment. Further, the systems discussed herein enable card issuers or payment providers, such as a banks, to issue contactless cards with tap-to functions to customers while maintaining a high-level security. The systems discussed differ from previous solutions because they provide a single platform for multiple issuers to provide the tap-to functionality. Traditionally, each issuer must set up and maintain their own systems to provide contactless card features. This includes maintaining their own hardware, software, databases, security protocols, and so forth, which can become extremely costly for the issuer to maintain. However, embodiments discussed enable issuers to offload much of the processing, storage, and security functionality to a neutral or central system. As will be discussed in more detail, the central system is configured to provide contactless card features for multiple issuers while maintaining a high level of security and data integrity. Each issuer's functionality and data may be separately managed and secured such that another issuer cannot access another issuer's data or functions. As will be discussed in more detail, these features may be provided by a switchboard system that is configured to process and perform each contactless card function in a secure manner. Additional benefits for issuers may include providing a highly secure authentication option for mobile web, which typically lack the robust authentication options available in a native application.

Further, embodiments discussed herein support tap-to mobile web experiences on both major mobile platforms (iOS®, Android®) by leveraging App Clips® and JavaScript® Software Development Kit (SDK) with WebNFC®. For iOS®, embodiments include providing a tap-to SDK including functions and services to perform the operations discussed herein on the iOS®platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apples® App Store.

In the Android® operating system environment, embodiments include utilizing a JavaScript SDK. The JavaScript SDK may be installed into a website, e.g., via website source code. The JavaScript SDK also includes functions to support NFC communications between the mobile device contactless card via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner and UIs libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

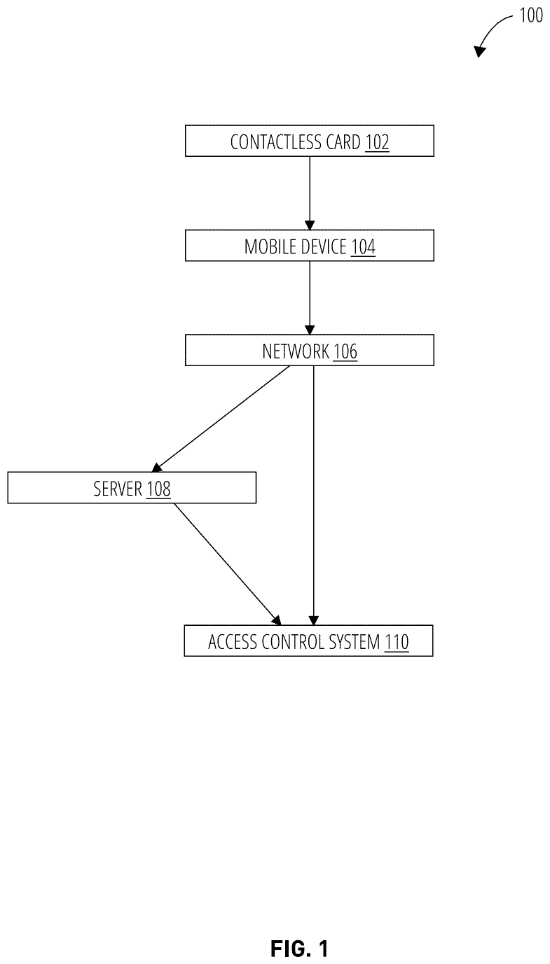

FIG. 1 illustrates a data transmission system 100 according to an example embodiment. As further discussed below, system 100 may include contactless card 102, mobile device 104, network 106, server 108, and access control system 110. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with mobile device 104.

System 100 may include mobile device 104, which may be a network-enabled mobile device. As referred to herein, a network-enabled mobile device may include, but is not limited to a computer device, or communications device including, e.g., a server, a network appliance, a personal computer, a workstation, a phone, a handheld PC, a personal digital assistant, a thin client, a fat client, an Internet browser, or other device. Mobile device 104 also may be, for example, an iPhone, iPod, iPad, Apple Watch from Apple® or any other mobile device running Apple's iOS® operating system, any device running Microsoft's Windows® Mobile operating system, any device running Google's Android® operating system, and/or any other smartphone, tablet, or a wearable mobile device, such as a smart watch, or any other suitable mobile or wearable device.

The mobile device 104 can include a processor circuit (e.g., processor) and a memory, and it is understood that the processor circuit may contain additional components, including processors, memories, error and parity/CRC checkers, data encoders, anticollision algorithms, controllers, command decoders, security primitives and tamperproofing hardware, as necessary to perform the functions described herein. The mobile device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, mobile device 104 of system 100 may execute one or more applications, such as software applications, that enable, for example, network communications with one or more components of system 100 and transmit and/or receive data.

The mobile device 104 may be in communication with one or more servers 108 via one or more networks 106, and may operate as a respective front-end to back-end pair with server 108. The mobile device 104 may transmit, for example from a mobile device application executing thereon, one or more requests to server 108. The one or more requests may be associated with retrieving data from server 108. The server 108 may receive the one or more requests from mobile device 104. Based on the one or more requests from mobile device 104, server 108 may be configured to retrieve the requested data from one or more databases (not shown). Based on receipt of the requested data from the one or more databases, server 108 may be configured to transmit the received data to mobile device 104, the received data being responsive to one or more requests.

System 100 may include one or more networks 106. In some examples, network 106 may be one or more of a wireless network, a wired network or any combination of wireless network and wired network, and may be configured to connect mobile device 104 to server 108 and/or access control system 110. For example, network 106 may include one or more of a fiber optics network, a passive optical network, a cable network, an Internet network, a satellite network, a wireless local area network (WLAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

Network 106 may further include a routing network used to route data between the mobile device 104, the server 108, and the access control system 110. The network diagram illustrating system 800 is an example diagram of a possible routing network to route data between the devices discussed above.

System 100 may include one or more servers 108. In some examples, server 108 may include one or more processors, which are coupled to memory. The server 108 may be configured as a central system server or platform to control and call various data at different times to execute a plurality of workflow actions. Server 108 may be configured to connect to the one or more databases. The server 108 may be connected to at least one mobile device 104 and/or the access control system 110. In some instances, server 108 is a bank server, such as a financial institution that issued the contactless card 102, or some other server not associated with a bank. Although only one server 108 is shown, multiple servers 108 may be in communication with the mobile device 104 and access control system 110 via network 106. With multiple servers, at least one server may be associated with the financial institution associated with the bank and another server may be associated just with the access control system 110, or with both the access control system 110 and the contactless card 102.

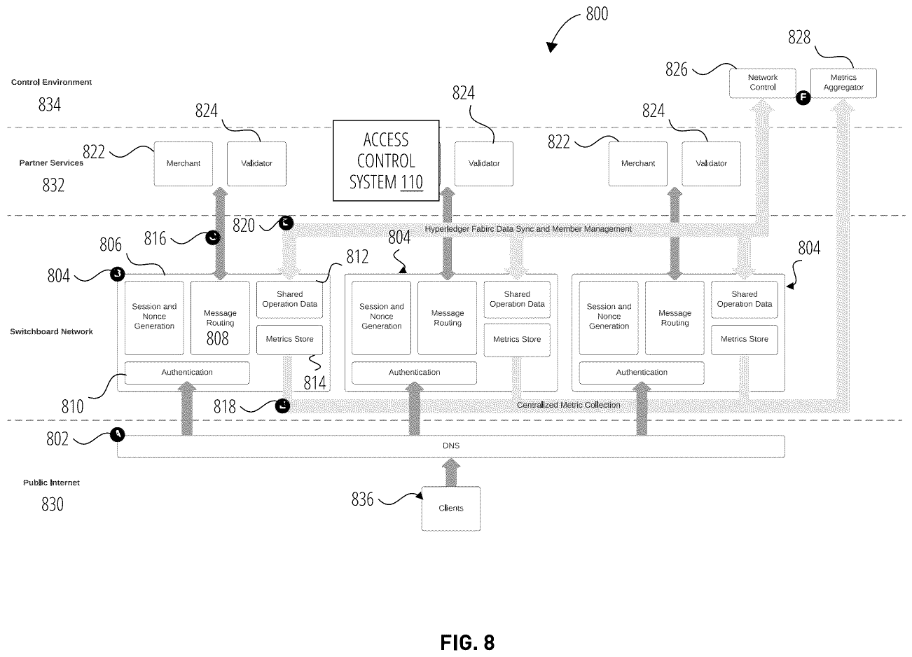

System 100 may include one or more access control systems 110. In some examples, access control system 110 may include an electronic door lock, a garage door, a smart locker control circuit, an automobile door or trunk, a control circuit for any of the above systems, or any other suitable access control system. In any event, the access control system 110 is in communication with either or both of the mobile device 104 and the server 108, where the server 108 includes the same server used by the mobile device 104 to verify the user account associated with the contactless card 102 or any other suitable server. An example system for implementing verification of the user account is described in FIG. 8 below. The server 108 can both verify the user account associated with the contactless card 102 and send control signals to activate or otherwise alter a state of the access control system 110, or separate servers are used, one for verifying the user account and one for sending control signals as described herein. In this disclosure, the server 108 is identified as performing both functions, but it should be understood that multiple servers can be used to perform each function.

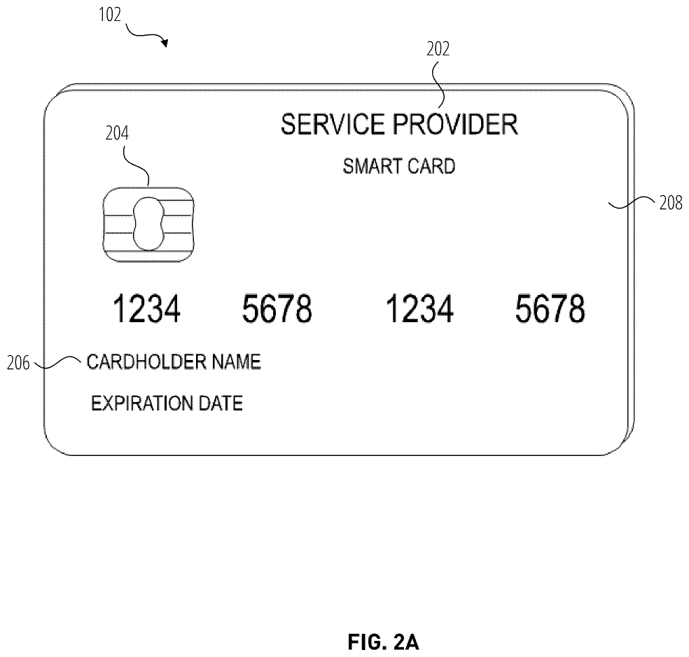

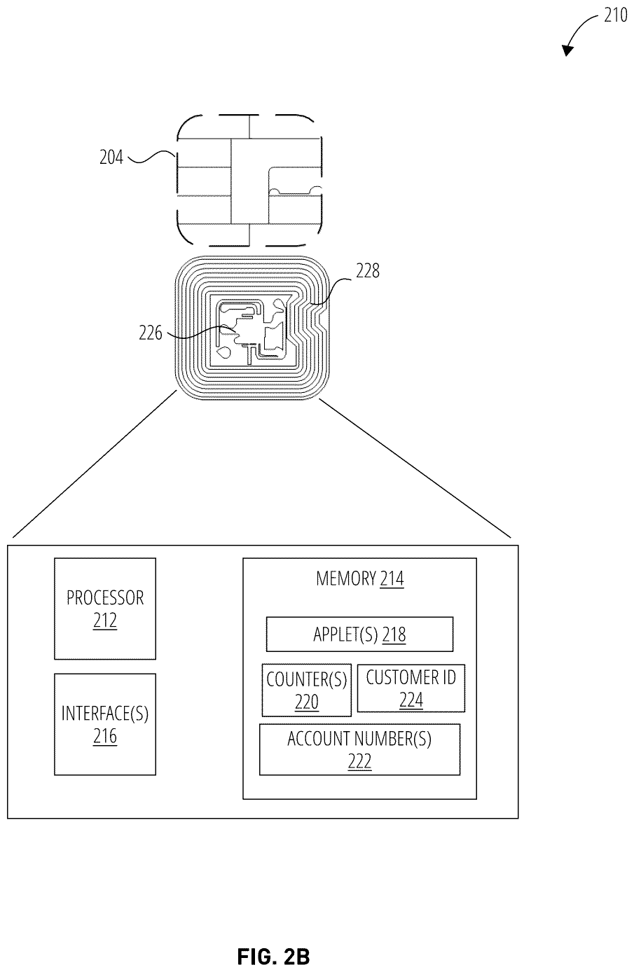

FIG. 2A illustrates an example configuration of a contactless card 102, which may include a contactless card, a smart card, a payment card, such as a credit card, debit card, or gift card, issued by a service provider as displayed as service provider indicia 202 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 208, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

The contactless card 102 may also include identification information 206 displayed on the front and/or back of the card, and a contact pad 204. The contact pad 204 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 2B. These components may be located behind the contact pad 204 or elsewhere on the substrate 208, e.g. within a different layer of the substrate 208, and may electrically and physically coupled with the contact pad 204. The contactless card 102 may also include a magnetic strip or tape, which may be located on the back of the card (not shown in FIG. 2A). The contactless card 102 may also include a Near-Field Communication (NFC) device coupled with an antenna capable of communicating via the NFC protocol. Embodiments are not limited in this manner.

Although contactless card 102 is illustrated similar to a credit card here in FIG. 2A, this representation should not be understood as limiting the contactless card 102 used herein. Any suitable or article may be used.

FIG. 2B illustrates an example transaction card component 210 of the contactless card 102. As illustrated in FIG. 2B, the contact pad 204 of contactless card 102 may include processing circuitry 226 for storing, processing, and communicating information, including a processor 212, a memory 214, and one or more interface(s) 216, such as a communication interface for communicating data to the network 106. It is understood that the processing circuitry 226 may contain additional components, including processors, memories, error and parity/CRC checkers, data encoders, anticollision algorithms, controllers, command decoders, security primitives and tamperproofing hardware, as necessary to perform the functions described herein.

The memory 214 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 214 may be encrypted memory utilizing an encryption algorithm executed by the processor 212 to encrypted data.

The memory 214 may be configured to store one or more applet(s) 218, one or more counter(s) 220, a customer identifier 224, and the account number(s) 222, which may be virtual account numbers. The one or more applet(s) 218 may comprise one or more software applications configured to execute on one or more contactless cards, such as a Java® Card applet. However, it is understood that applet(s) 218 are not limited to Java Card applets, and instead may be any software application operable on contactless cards or other devices having limited memory. The one or more counter(s) 220 may comprise a numeric counter sufficient to store an integer. The customer identifier 224 may comprise a unique alphanumeric identifier assigned to a user of the contactless card 102, and the identifier may distinguish the user of the contactless card from other contactless card users. In some examples, the customer identifier 224 may identify both a customer and an account assigned to that customer and may further identify the contactless card 102 associated with the customer's account. As stated, the account number(s) 222 may include thousands of one-time use virtual account numbers associated with the contactless card 102. An applet(s) 218 of the contactless card 102 may be configured to manage the account number(s) 222 (e.g., to select an account number(s) 222, mark the selected account number(s) 222 as used, and transmit the account number(s) 222 to a mobile device for autofilling by an autofilling service.

The processor 212 and memory elements of the foregoing exemplary embodiments are described with reference to the contact pad 204, but the present disclosure is not limited thereto. It is understood that these elements may be implemented outside of the contact pad 204 or entirely separate from it, or as further elements in addition to processor 212 and memory 214 elements located within the contact pad 204.

In some examples, the contactless card 102 may comprise one or more antenna(s) 228. The one or more antenna(s) 228 may be placed within the contactless card 102 and around the processing circuitry 226 of the contact pad 204. For example, the one or more antenna(s) 228 may be integral with the processing circuitry 226 and the one or more antenna(s) 228 may be used with an external booster coil. As another example, the one or more antenna(s) 228 may be external to the contact pad 204 and the processing circuitry 226.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 228, processor 212, and/or the memory 214, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 218 may be added to contactless cards to provide one or more authentication codes, verification codes, encrypted data, and other verification codes or data used for verifying the identity of the user or user account associated with the contactless card 102. Hereinafter, this code for verifying the identity of the user account will be referred to as an authentication code. Applet(s) 218 may be configured to respond to one or more requests, such as near field data exchange requests, from a reader, such as a mobile NFC reader (e.g., of a mobile device or point-of-sale terminal), and produce an NDEF message that comprises a cryptographically secure authentication code encoded as an NDEF text tag.

One example of an NDEF authentication code is an NDEF short-record layout (SR=1). In such an example, one or more applet(s) 218 may be configured to encode the authentication code as an NDEF type 4 well known type text tag. In some examples, NDEF messages may comprise one or more records. The applet(s) 218 may be configured to add one or more static tag records in addition to the authentication code record.

In some examples, the one or more applet(s) 218 may be configured to emulate an RFID tag. The RFID tag may include one or more polymorphic tags. In some examples, each time the tag is read, different cryptographic data is presented that may indicate the authenticity of the contactless card. Based on the one or more applet(s) 218, an NFC read of the tag may be processed, the data (e.g., the authentication code or encrypted data) may be transmitted to a server, such as a server of a banking system, or the mobile device 104 and the data (i.e., and thereby the user account) may be validated at the server or mobile device 104.

In some examples, the contactless card 102 and server 108 from FIG. 1 may include certain data such that the card may be properly identified. The contactless card 102 may include one or more unique identifiers (not pictured). Each time a read operation takes place, the counter(s) 220 may be configured to increment. In some examples, each time data from the contactless card 102 is read (e.g., by a mobile device), the counter(s) 220 is transmitted to the server for validation and determines whether the counter(s) 220 are equal (as part of the validation) to a counter of the server.

The one or more counter(s) 220 may be configured to prevent a replay attack. For example, if a cryptogram has been obtained and replayed, that cryptogram is immediately rejected if the counter(s) 220 has been read or used or otherwise passed over. If the counter(s) 220 has not been used, it may be replayed. In some examples, the counter that is incremented on the card is different from the counter that is incremented for transactions. The contactless card 102 is unable to determine the application transaction counter(s) 220 since there is no communication between applet(s) 218 on the contactless card 102.

In some examples, the counter(s) 220 may get out of sync. In some examples, to account for accidental reads that initiate transactions, such as reading at an angle, the counter(s) 220 may increment but the application does not process the counter(s) 220. In some examples, when the mobile device 104 is woken up, NFC may be enabled and the mobile device 104 may be configured to read available tags, but no action is taken responsive to the reads.

To keep the counter(s) 220 in sync, an application, such as a background application, may be executed that would be configured to detect when the mobile device 110 wakes up and synchronize with the server of a banking system indicating that a read that occurred due to detection to then move the counter(s) 220 forward. In other examples, Hashed One Time Password may be utilized such that a window of mis-synchronization may be accepted. For example, if within a threshold of 10, the counter(s) 220 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 220 increase in the appropriate sequence, then it possible to know that the user has done so.

The key diversification technique described herein with reference to the counter(s) 220, master key, and diversified key, is one example of encryption and/or decryption a key diversification technique. This example key diversification technique should not be considered limiting of the disclosure, as the disclosure is equally applicable to other types of key diversification techniques. Any suitable key diversification technique that can provide an authentication key as described herein is contemplated.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication code or message may be delivered (for example to the mobile device 104 of FIG. 1) as the content of a text NDEF record in hexadecimal ASCII format. In another example, the NDEF record may be encoded in hexadecimal format.

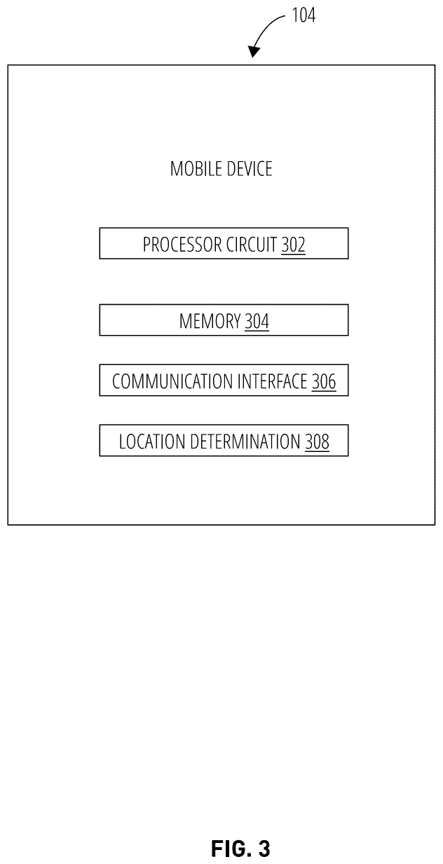

FIG. 3 illustrates a block diagram of an example mobile device 104 in accordance with some embodiments of the present disclosure. In some examples, the mobile device 104 includes a processor circuit 302 and a memory 304, the processor circuit 302 being for executing instructions stored on the memory 304, including one or more computer applications. The mobile device 104 further comprises a communication interface 306 for communicating with the contactless card 102 and/or the server 108 over the network 106. As described above, the mobile device 104 can include any suitable wired or wireless connected computing device. Additionally, the mobile device 104 may include a location determination 308 component such as a global positioning system (GPS) and circuitry therefor, or any other suitable location determination circuit or device. The mobile device 104 may be equipped with device sensors, including GPS and Bluetooth along with crowd-sourced Wi-Fi hotspot and cell tower location determination circuitry to determine the approximate location of the mobile device 104.

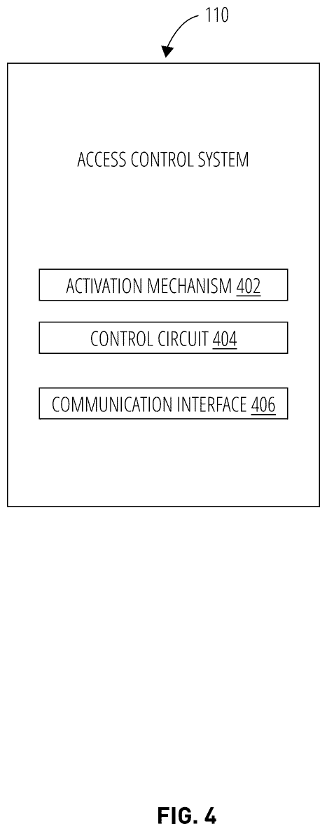

FIG. 4 illustrates a block diagram of an example access control system 110 in accordance with some embodiments. In some examples, the access control system 110 includes a door with network connected locking mechanism, or a garage door system with a network connected controller. The access control system may also be, for example, a smart locker with network connected control system or any other suitable system. In some embodiments, the access control system 110 includes an activation mechanism 402 of some kind such as an electronic lock, a pneumatic lock, a garage door motor, mechanical device, electronic actuator, or any other suitable activation mechanism. The access control system 110 further comprises a control circuit 404 for controlling the activation mechanism 402. For example, in embodiments where the access control system 110 includes a garage door system or a locking door system, the control circuit 404 can include appropriate control circuitry for controlling or triggering the garage door to open or close or to lock or unluck the door. Any other appropriate control circuit 404 is also contemplated.

In some embodiments, the access control system 110 includes one or more communication interface 406 for receiving communications, including control signals and the like, or sending communications to various devices on the network 106. For example, control signals sent from the mobile device 104 or the server 108 or any other suitable device are to be received by the communication interface 406 and processed by the access control system 110.

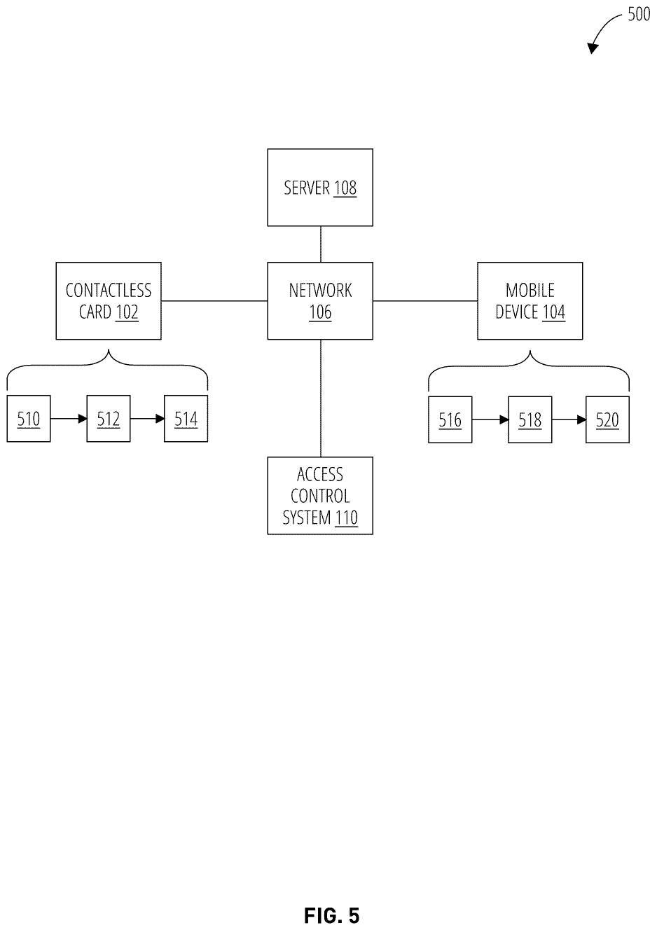

FIG. 5 illustrates a data transmission system 500 according to an example embodiment. Data transmission system 500 may include the contactless card 102, the mobile device 104, the server 108, and/or, the access control system 110 of FIG. 1, in communication, for example via network 106. Although FIG. 5 shows single instances of components of system 500, system 500 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 5, system 500 may be configured to implement key diversification. For example, a sender and recipient may desire to exchange data (e.g., an authentication code) via the contactless card 102 and the mobile device 104. As explained above, although single instances of contactless card 102 and mobile device 104 may be included, it is understood that one or more contactless cards 102 and one or more mobile devices 104 may be involved so long as each party shares the same shared secret symmetric key. In some examples, the contactless card 102 and mobile device 104 may be provisioned with the same master symmetric key. Further, it is understood that any party or device holding the same secret symmetric key may perform the functions of the contactless card 102 and similarly any party holding the same secret symmetric key may perform the functions of the mobile device 104. In some examples, the symmetric key may comprise the shared secret symmetric key which is kept secret from all parties other than the contactless card 102 and the mobile device 104 involved in exchanging the secure data. It is further understood that both the contactless card 102 and mobile device 104 may be provided with the same master symmetric key, and further that part of the data exchanged between the contactless card 102 and mobile device 104 comprises at least a portion of data which may be referred to as the counter value. The counter value may comprise a number that changes each time data is exchanged between the contactless card 102 and the mobile device 104.

System 500 may include one or more networks 106. In some examples, network 106 may be one or more of a wireless network, a wired network or any combination of wireless network and wired network, and may be configured to connect one or more contactless card 102 and one or more mobile device 104 to each other and to server 108. For example, network 106 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like. Additionally, the network 106 can, via wireless or wired connection, connect the server 108, the contactless card 102 or the mobile device 104 with the access control system 110 or a control circuit therefor.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. Network 106 may further include one network, or any number of the exemplary types of networks mentioned above, operating as a stand-alone network or in cooperation with each other. Network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

In some examples, one or more contactless card 102 and one or more mobile device 104 may be configured to communicate and transmit and receive data between each other without passing through network 106. For example, communication between the one or more contactless card 102 and the one or more mobile device 104 may occur via at least one of NFC, Bluetooth, RFID, Wi-Fi, and/or the like.

In some embodiments, a user associated with a user account associated with the contactless card 102 attempts to alter a control state or other state of the access control system 110. To initiate this alteration of the control state, the user brings the contactless card 102 close to the mobile device 104 to transmit the authentication code from the contactless card 102 to the mobile device 104 via NFC, RFID, or any other suitable method. Production of the authentication code is described in more detail herein.

At block 510, when the contactless card 102 is preparing to process the sensitive data with symmetric cryptographic operation, the processor 212 may update a counter. In addition, the contactless card 102 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 512, the contactless card 102 may take the selected cryptographic algorithm, and using the master symmetric key, process the counter value. For example, the sender may select a symmetric encryption algorithm, and use a counter which updates with every conversation between the contactless card 102 and the mobile device 104. The contactless card 102 may then encrypt the counter value with the selected symmetric encryption algorithm using the master symmetric key, creating a diversified symmetric key.

In some examples, the counter value may not be encrypted. In these examples, the counter value may be transmitted between the contactless card 102 and the mobile device 104 at block 512 without encryption.

At block 514, the diversified symmetric key may be used to process the sensitive data before transmitting the result to the mobile device 104. For example, the contactless card 102 may encrypt the sensitive data using a symmetric encryption algorithm using the diversified symmetric key, with the output comprising the protected encrypted data, this is also referred to as the authentication code, to be sent to the mobile device 104 for verification. The contactless card 102 may then transmit the authentication code, along with the counter value, to the mobile device 104 for processing.

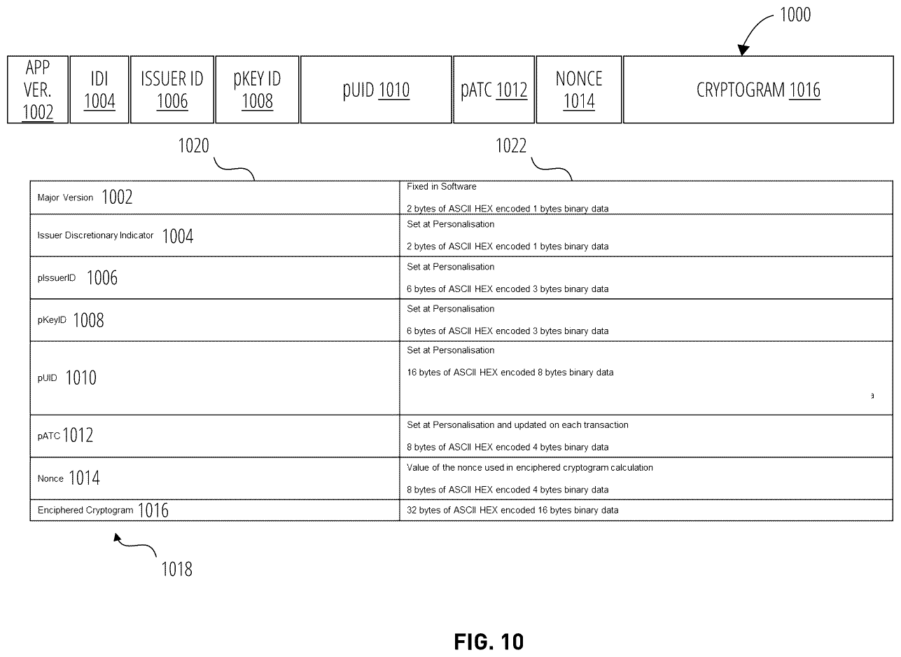

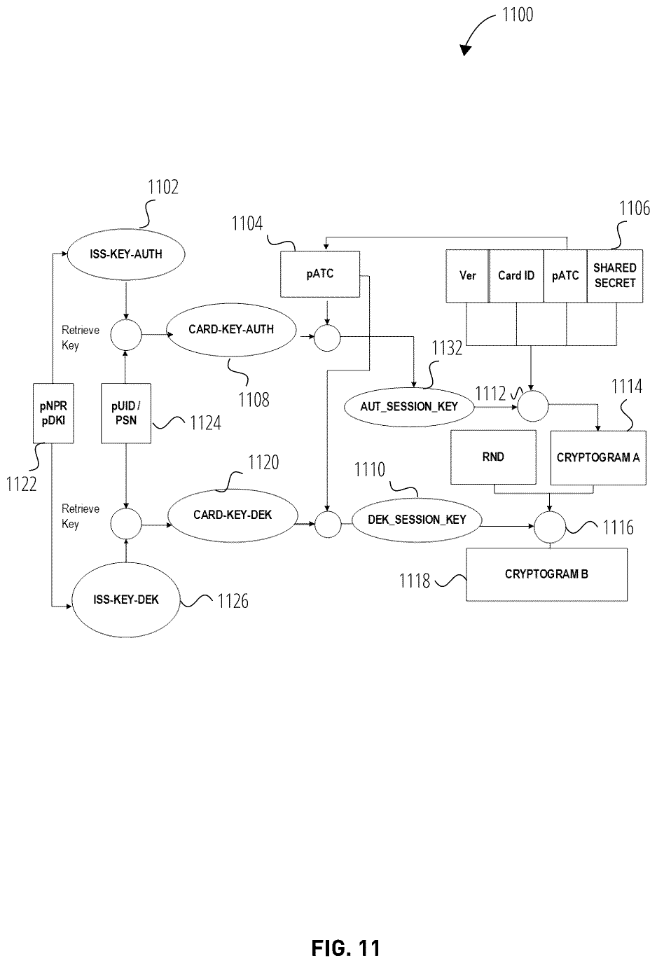

FIGS. 11-14 provide a more detailed description of an example embodiment where the encrypted data or authentication code is generated for output by the contactless card 102. FIG. 10 illustrates an example message, including the encrypted data or authentication code generated by the contactless card 102 and output to the mobile device 104.

As described above, the mobile device 104 includes memory to store instructions thereon, and a processor circuit to execute the instructions. In response to executing the instructions, the processor circuit is caused to receive the authentication code (along with the counter value) from a communications interface of the contactless card 102 associated with the user account, the user account also being associated with a computer application executing on the contactless card 102. For example, the user account may be associated with the service provider or bank of the contactless card 102 and the contactless card 102 is associated with the user account and the user account is associated with an application operating on the mobile device 104 as well.

At block 516, the mobile device 104 may first take the counter value and then perform the same symmetric encryption using the counter value as input to the encryption, and the master symmetric key as the key for the encryption. The output of the encryption may be the same diversified symmetric key value that was created by the sender.

At block 518, the mobile device 104 may then take the protected encrypted data and using a symmetric decryption algorithm along with the diversified symmetric key, decrypt the authentication code.

At block 520, as a result of the decrypting the protected encrypted data, the original sensitive data may be revealed.

The next time sensitive data needs to be sent from the contactless card 102 to the mobile device 104, a different counter value may be selected producing a different diversified symmetric key. By processing the counter value with the master symmetric key and same symmetric cryptographic algorithm, both the contactless card 102 and mobile device 104 may independently produce the same diversified symmetric key. This diversified symmetric key, not the master symmetric key, is used to protect the sensitive data.

As explained above, both the contactless card 102 and mobile device 104 each initially possess the shared master symmetric key. The shared master symmetric key is not used to encrypt the original sensitive data. Because the diversified symmetric key is independently created by both the contactless card 102 and mobile device 104, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the contactless card 102 and the mobile device 104 may be governed by symmetric requirements for how often to create a new diversification value, and therefore a new diversified symmetric key. In an embodiment, a new diversification value and therefore a new diversified symmetric key may be created for every exchange between the contactless card 102 and mobile device 104.

In some examples, the key diversification value may comprise the counter value. Other non-limiting examples of the key diversification value include: a random nonce generated each time a new diversified key is needed, the random nonce sent from the contactless card 102 to the mobile device 104; the full value of a counter value sent from the contactless card 102 and the mobile device 104; a portion of a counter value sent from the contactless card 102 and the mobile device 104; a counter independently maintained by the contactless card 102 and the mobile device 104 but not sent between the two devices; a one-time-passcode exchanged between the contactless card 102 and the mobile device 104; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the contactless card 102 and the mobile device 104. In effect, this may create a one-time use key, such as a single-use session key.

Once the encrypted data or authentication code has been sent to the mobile device 104, either the mobile device 104 itself can verify the user account associated with the contactless card 102, or the mobile device 104 can send the authentication code to server 108 or any other suitable computing device that knows what the authentication code should be, to verify the identity of the user attempting to alter the state of the access control system 110. In any event, the mobile device 104 or some other server 108 is to determine, based on the authentication code, whether the user account is authorized to alter a state of the access control system.

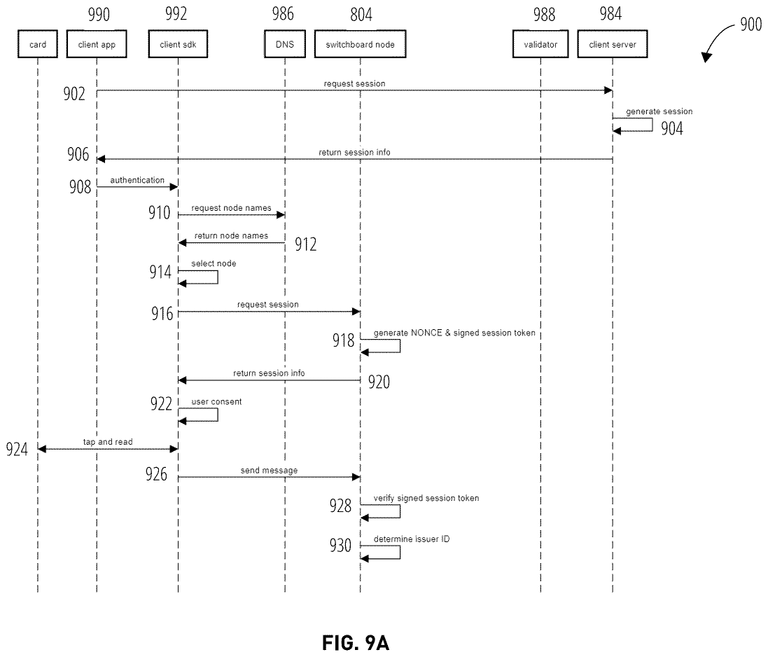

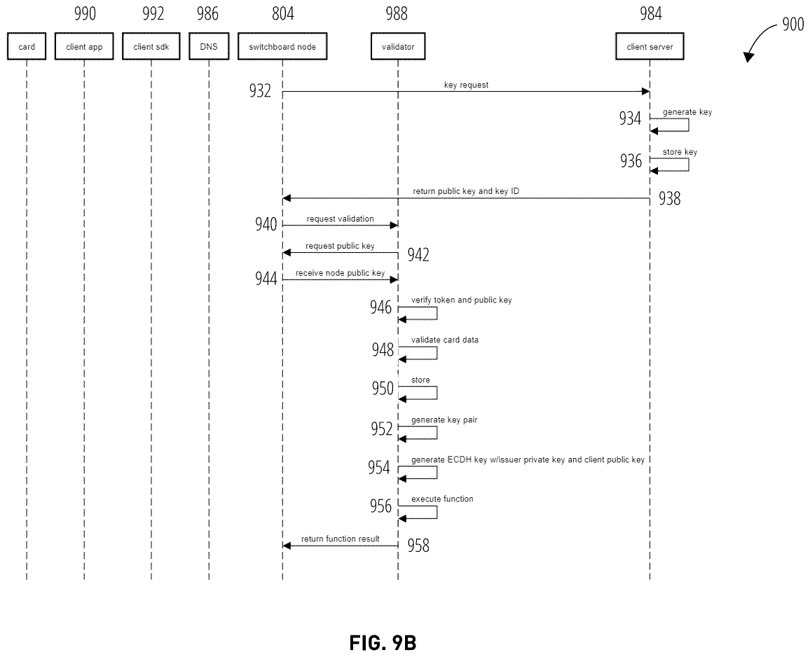

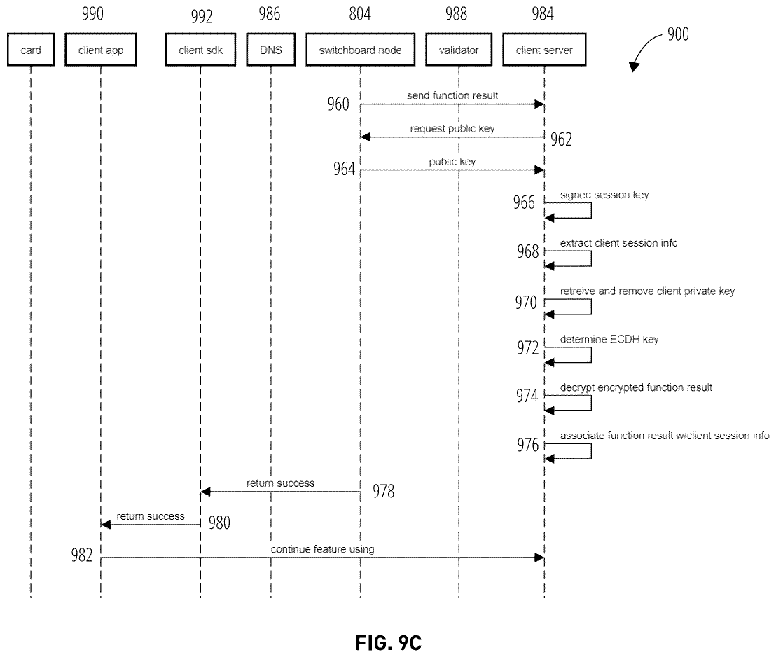

In some embodiments, the authentication code or encrypted data can be sent to a switchboard system for verification, such as the switchboard system illustrated in FIG. 8. FIGS. 9A-9C illustrate example sequences of how the encrypted data is transmitted from contactless card 102 to the server 108, which is referred to as client server 984 in FIGS. 9A-9C.

Using the location determination 308 device or circuit shown in FIG. 4, the mobile device 104 is further to determine a geographic location of the mobile device 104. The reason for determining the geographic location of the mobile device 104 is to make sure that the user attempting to access or alter the state of the access control system 110 is actually located near the access control system 110 and it isn't an unauthorized person attempting to access the access control system 110 from afar.

In some embodiments, the system uses the location determination 308 circuitry to verify that the mobile device 104 is located within ten to fifty feet of the access control system 110. Alternatively, the location determination 308 circuitry might not be so precise, and it might only be necessary to determine whether the mobile device 104 is within a general area, such as a city, zip code, street, block, etc. of the access control system 110.

In some embodiments, to determine whether the user account is authorized to alter the state of the access control system 110, a processor circuit 302 of the mobile device 104 is further to send the authentication code to an authentication system associated with the user account. For example, the mobile device 104 can send or transmit the authentication code to the server 108, which executes an authentication system thereon. The authentication system on the server 108 can compare the authentication code to an expected authentication code for the user account. If the received authentication code corresponds to the expected authentication code for the user account, then the user account is verified. If, however, the authentication code received from the mobile device 104 does not correspond to the expected authentication code, the user account is not verified and the user will not be able to access the access control system 110 or alter a state thereof.

In response to the user account being verified and the mobile device 104 being within the predefined distance of the access control system 110, a control signal is caused (i.e., by the mobile device 104 or the server 108) to be sent to the access control system 110 to access the access control system 110 or otherwise alter a state of the access control system 110. For example, in some embodiments, the access control system 110 comprises one or more of the following an electronic door lock, or control circuit thereof, a garage door control circuit, a locker control circuit, an automobile door or trunk control circuit, a manufacturing facility control circuit, or any other suitable access control system 110. In some embodiments, the control signal includes at least one instruction to activate, deactivate, unlock, lock, or alter a system setting of the access control system, including a control circuit thereof. This can include locking or unlocking a door, opening or closing a garage door, opening or closing a locker, turning on manufacturing equipment, clocking into an employment timecard, etc. Any suitable control signal can be sent to activate, deactivate, access, prevent access, or otherwise alter the state of the access control system 110, or a control circuit thereof.

In some embodiments, the mobile device 104 sends the control signal and other instances, the server 108 or any other suitable computing device sends the control signal. In embodiments where the mobile device 104 sends the control signal to the access control system 110, after the authentication system of the server 108 has verified the user account, an authorization message confirming the user account is permitted to access the access control system 110 or alter a state thereof, is sent to the mobile device 104. The processor circuit 302 of the mobile device 104 is to receive the authorization message from the authentication system indicating that the user account is authorized to alter the state of the access control system. As discussed above, the mobile device 104 is further to determine that the geographic location of the mobile device 104 is within the predefined distance of the access control system 110. In response to receiving the authorization message from the authentication system and determining that the geographic location of the mobile device 104 is within the predefined distance of the access control system 110, the mobile device 104 is to cause the control signal to be sent to the access control system 110 to alter the state of the access control system 110, as described herein.

Alternatively, as described above, the mobile device 104 itself can verify that the user account is authorized. In response to the mobile device 104 determining that the user account is authorized by comparing the authentication code to the expected authentication code for the user account and the geographic location of the mobile device 104 is within the predefined limit, the mobile device 104 is to send the control signal directly, via network 106, to the control circuit of the access control system 110 to access the access control system 110 or alter the state of the control circuit of the access control system 110. In another embodiment, the mobile device 104 does the authentication code and location verifications and sends the control signal to server 108, and server 108 sends the control signal to access or alter the state of the access control system 110. In other embodiments, the mobile device 104 is to send a message to a separate computing system (not shown) in communication with the access control system, the message to cause the separate computing system to send the control signal to a control circuit of the access control system to alter the state thereof.

In some embodiments, the server 108 is the device that performs the authentication code check and the location check and then sends the control signal to the access control system 110. For example, the mobile device 104 may send its geographic location to the server 108, as well as the authentication code. Then the server 108 may verify, based on the authentication code, that the user account is authorized to access the access control system 110 or alter a state of the control circuit or other component of the access control system 110. The server 108 will further determine, based on the geographic location received from the mobile device 104, if the mobile device 104 is within the predetermined distance of the access control system 110. If the user account is authorized and the mobile device 104 is within the predetermined distance, the server 108 may send the control signal to the access control system 110 to access the access control system 110 or alter the control circuit thereof.

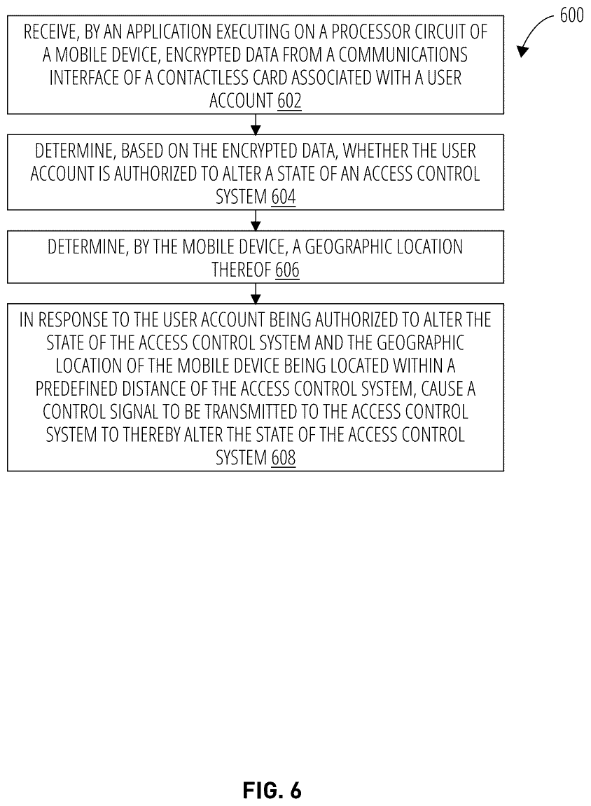

FIG. 6 illustrates a method 600 for accessing an access control system or altering a state thereof, according to some embodiments of the present disclosure. At block 602, the method 600 includes receiving, by an application executing on a processor circuit of a mobile device, encrypted data from a communications interface of a contactless card associated with a user account. At block 604, the method 600 includes determining, based on the encrypted data, whether the user account is authorized to alter a state of an access control system. At block 606, the method 600 includes determining, by the mobile device, a geographic location thereof. At block 608, the method 600 includes, in response to the user account being authorized to alter the state of the access control system and the geographic location of the mobile device being located within a predefined distance of the access control system, causing a control signal to be transmitted to the access control system to thereby alter the state of the access control system.

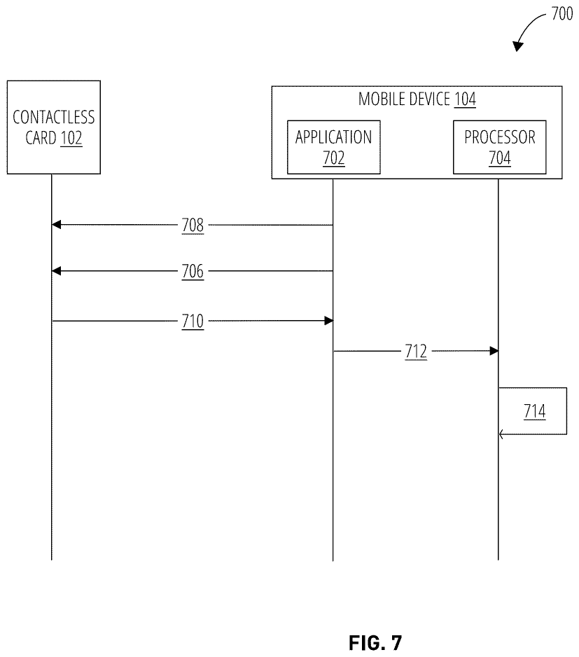

FIG. 7 is a timing diagram illustrating an example sequence for providing authenticated access according to one or more embodiments of the present disclosure. Sequence flow 700 may include contactless card 102 and mobile device 104, which may include an application 702 and processor 704 or processor circuitry.

At line 708, the application 702 communicates with the contactless card 102 (e.g., after being brought near the contactless card 102). Communication between the application 702 and the contactless card 102 may involve the contactless card 102 being sufficiently close to a card reader (not shown) of the mobile device 104 to enable NFC data transfer between the application 702 and the contactless card 102.

At line 706, after communication has been established between mobile device 104 and contactless card 102, contactless card 102 generates a message authentication code (MAC) cryptogram. In some examples, this may occur when the contactless card 102 is read by the application 702. In particular, this may occur upon a read, such as an NFC read, of a near field data exchange (NDEF) tag, which may be created in accordance with the NFC Data Exchange Format. For example, a reader application, such as application 702, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 702 may be configured to transmit a request to contactless card 102, the request comprising an instruction to generate a MAC cryptogram.

At line 710, the contactless card 102 sends the MAC cryptogram (i.e., the authentication code referred to above) to the application 702. In some examples, the transmission of the MAC cryptogram occurs via NFC, however, the present disclosure is not limited thereto. In other examples, this communication may occur via Bluetooth, Wi-Fi, or other means of wireless data communication. At line 712, the application 702 communicates the MAC cryptogram to the processor 704.

At line 714, the processor 704 verifies the MAC cryptogram pursuant to an instruction from the application 702. For example, the MAC cryptogram may be verified, as explained below. In some examples, verifying the MAC cryptogram may be performed by a device other than mobile device 104, such as a server (e.g., server 108 from FIG. 5, or any other suitable device) of a banking system in data communication with the mobile device 104. For example, processor 704 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 8 illustrates an example of a routing network that can be included in network 106 described above with respect to FIG. 1. The routing network, is embodied by system 800 and can be used to route the encrypted data discussed above between the mobile device 104 and the server 108 and access control system 110 described in FIG. 1 and FIG. 5 above. The routing network embodied by system 800 can also be used to route an access control request, the access control request including a message requesting access to the access control system 110. The access control request can also include the encrypted data described above. The access control request can be routed from the mobile device 104 through the routing network embodied by system 800. The system 800 includes additional devices and systems configured to enable contactless card issuers to tap-to-card services. Specifically, system 800 enables any number of issuer systems to provide card services to their clients through a switching fabric, i.e., a switchboard system in a secure and safe manner. This switching fabric is used to help verify the authentication code or encrypted data sent from the contactless card 102 to the mobile device 104 as described above. The switching fabric described herein can also be used to send instructions to a server in communication with the access control system 110 to have the server send instructions to the access control system 110 to either alter a state thereof (e.g., change a control state of a control circuit of the access control system 110) or otherwise provide access to the access control system 110.

In embodiments, the switchboard system 800 includes one or more nodes 804 configured to perform routing operations. Each switchboard node 804 may include a session and nonce generator 806, a message router 808, an authentication 810, an operation data 812 store, and a metrics store 814. Further, each of the nodes may be configured the same and share configurations, but each switchboard node 804 may independently process and route messages and requests to the appropriate systems, such as the merchant systems and issuer systems. Each of the nodes 804 is configured to act as a broker of trust between an issuer system, the merchant system 822, and/or validation system 824, for example. A merchant system can also be a control circuit for the access control system 110. That is, while FIG. 8 shows that the routing network system 800 can route data through the hyperledger to the partner services 832, including merchant system 822, the merchant system 822 can be replaced by the control circuit for the access control system 110 or can be replaced by the access control system 110 itself and the access control system 110 trusts the decisions of the authentication 810 of the nodes 804. Each switchboard node 804 is configured to route each message to the correct issuer system while maintaining data security. For example, a switchboard node 804 may route a message between an issuer system and access control system 110 while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 804. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 804 may operate in a cloud-based computing environment, e.g., a collection of hardware, software, and networking components that enable the delivery of cloud computing services. The switchboard nodes 804 and the computing services are delivered over the Internet, and they can be accessed from anywhere in the world with an Internet connection. In embodiments, a client 836 may access a switchboard node 804 through Domain Name System 802 or domain name system (DNS). The DNS 802 a hierarchical and distributed naming system for computers, services, and other resources connected to the Internet or other networks. It associates various information with domain names assigned to each registered participant. In one example, the DNS 802 may translate a name known to software executing on a client 836 to route data to one or more of switchboard node 804 of the switchboard system. In embodiments, the DNS 802 may generate into a number, such as an Internet Protocol (IP) address, an address record (A-record), or another Host name (C-name record). At a high level, the Domain Name System 802 translates known domain names to numerical Internet Protocol (IP) addresses needed for locating and identifying computer services and devices with the underlying network protocols. Clients use the global DNS system to select the best node to use.

In one example, for a client to utilize DNS to resolve and communicate with one or more nodes of a switchboard system, such as the client 836, the DNS 802, and the switchboard node 804. client 836 sends a request to a default DNS server for a text record switchboard. {domain}. {tld}. The text record may be preconfigured in a client app and/or client SDK. The DNS 802 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP)
   Used For: communicating with a node 804

In embodiments, the client 836 may determine the current timezone. For example, the client app or sdk may utilize a get current timezone function, such as in JavaScript: Intl.DateTimeFormat( ).resolvedOptions( ).timeZone). Embodiments are not limited in this manner, and the app or sdk may determine the timezone via another/different function call. Further, the client 836 is configured to map the timezone to a region or short-version identifier of the region. One example includes America/New_York->na-e. The region may be based on DNS names, for example. Table 1 illustrates a few examples of timezone mappings to regions:

TABLE 1

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples; other timezone-to-region mappings may be utilized. Further and in embodiments, regions can also be represented as a bidirectional graph structure with the edges representing geographic neighbors. For example, na-e<->na-w and sa <->na-w and sa<->na-e. This representation is useful for node selection.

Further, the client 836 may identify or select a DNS record option previously returned that is in the region. If there are multiple matches, the client may select one at random. If there's no node available in a region, the client 836 may determine and use a data graph of neighboring regions to select a node in the closest region where a node is available. For example, sa has no node but is connected to na-e where there is a node and so na-e is selected.

Embodiments include the client 836 resolving a selected node's hostname. In embodiments, the client 836 automatically resolves the hostname using the client's HTTP request default resolver. Further, the DNS 802 may return a result, and the client 836 may communicate with a switchboard node 804 and begin interacting with the switchboard.

In embodiments, a client 836 communicates with the switchboard system to perform one or more of the partner services 832, such as conducting a transaction with a merchant, validate the customer, or other tap-to functions, such grant access to an access control system 110 or otherwise alter a state of the access control system 110. Once the client 836 identifies a switchboard node 804 and resolves an address to communicate with the switchboard node 804, the client 836 may send one or more messages to the switchboard node 804 to authenticate and perform the operation. The switchboard node 804 includes an authentication 810 function that is configured to authenticate the client 836, such as verifying the encrypted data or the authentication code from the mobile device 104 from FIG. 5. In embodiments, the client 836 sends a message or authorization request to the switchboard node 804 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 2 describes the value, name, and meaning:

TABLE 2

| Value | Name | Meaning |
|---|---|---|
| 65535 | Client ID | Individual identifier of client |
| GReyx5BuEAaE72bWbFZJfHRL8Dbt1Uum | Client Key | Randomly assigned key |

The switchboard node 804 may authorize or authenticate the client 836 or user, and the switchboard node 804 may utilize the additional components, such as the session and nonce generator 806 and message router 808, to perform the operations. Note the Validators validation system 824 never interact with the merchant system 822, nor vice versa. The nodes 804 broker all communication.

In embodiments, the switchboard system 800 may utilize a hyperledger fabric 820 to manage synchronizing the shared operation data 812 and member management across the network. The hyperledger fabric 820 is distributed ledger framework having a permissioned network model that only authorized participants can join the network and access the data that is stored on a ledger.

In embodiments, the hyperledger fabric 820 may be generated by creating one or more set of peers, an ordering service, and a channel. Once the network is created, the system 800 deploys chaincode to the network or nodes 804 permitted to access the fabric. The chaincode is the code that runs on the blockchain and executes the network control 826 and operation data 812 logic code. Once the chaincode is deployed, each of the switchboard nodes 804 is configured to invoke transactions on the blockchain to add data to the blockchain, e.g., the operational data. A switchboard node 804 or another device can query the ledger to retrieve data. The ledger is a distributed database that stores all of the data that has been added to the blockchain.

All nodes 804 keep an independently verifiable log of their actions that can be transmitted to a centralized aggregator to build a picture of overall network usage. At a central level, system 800 can manage network operation data and management and have a centralized view of network use, aggregated and abstracted to the appropriate level.

FIG. 9A-FIG. 9C illustrate an example sequence 900 to perform operations between a contactless card 102 and services provided by a card issuer, merchant, or access control system 110 from FIG. 1, or control circuit therefor. The illustrated sequence 900 includes actions and communications performed by a contactless card 102, a client 836 including a client app 990 and a client SDK 992, a DNS 986, a switchboard system including one or more nodes 804, a partner services 832 including a merchant, access control system 110, and/or validator 988, and control services 834 including a client server 984 or system. In embodiments, the client app 990 may be any application configured to execute on a client 836, such as a banking app, a merchant app, a social media app, a travel app, a gaming app, a productivity app, an entertainment app, and so forth. In embodiments, the client app 990 includes a web browser to provide websites and pages. The client app 990 may include and/or utilize the client SDK 992, which may be a set of instructions that enable the client app 990 to communicate with other components of the switchboard system. In some examples, the client 836 is equivalent to the mobile device 104 and the client app 990 can be the application operating on the mobile device 104 in FIG. 1 above.

In embodiments, at 902 the client 836 including the client app may send a request and establish a session with a client server 984 such that a result may be associated with the correct client device or user. The request establishes a relationship between the client device and client server, which may be an issuer server. At 904, the client server 984 generates a session and CLIENT SESSION INFORMATION. At 906, the client server 984 returns the session information, e.g., the CLIENT SESSION INFORMATION. In embodiments, the CLIENT SESSION INFORMATION may be the Client implementation-specific user session identification information.

At 908, the client 836 may initiate a contactless card authentication process with the client 836. For example, the client 836 may call a function and/or pass information to the client 836 to initiate authentication via a contactless card. At 910-914, the client 836 may utilize DNS to identify a node and establish communication with the node. Specifically, at 910, the client 836 including the client SDK 992 may send a request for switchboard hostnames, and at 912 the the DNS 986 may return information including one or more hostnames. At 914, the client 836 may determine a switchboard node to communicate.

At 916, the client 836 may send a request for a session to the switchboard system 800. In embodiments, the request for a session may be for a function request in the format <FUNCTION REQUEST>. In embodiments, the FUNCTION REQUEST may be the data/function that the client would like to request once a contactless card has been validated. The function could be for any service discussed herein, e.g., authenticate the user, perform a transaction, request autofill data, authenticate the user and send control signals to an access control system etc. At 918, switchboard system 800 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 108 private key. The switchboard system 108 may include a NODE PUBLIC/PRIVATE KEY, which is a keypair used to sign and validate JWTs.

At 920, the switchboard system 800 may return session information to the client 836. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 922, the client SDK 992 may determine and/or receive user consent to the terms of service. In one example, the client SDK 992 captures and records the user consent to <FUNCTION TOS> on <CONSENT DATE> with <TOS VERSION>. The CONSENT DATE may be the timestamp for the user's consent to the TOS.

At 924, the client 836 exchanges one or more messages with a contactless card. In one example, the exchange may be based on the contactless card being tapped to a client device. In embodiments, the client SDK 992 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an NDEF message format example.

TABLE 3

| Byte | Data Item | Value |
|---|---|---|
| 00 | NDEF Message | D1 (only record) |
| | Tag | |
| 01 | Length of | 01 |
| | Record Type | |
| 02 | Length of | 33 |
| | Record | |
| 03 | text record | 54 |
| | type | |
| 04 | Length of | 02 |
| | Language | |
| 05-06 | Language | 65 6E (“en”) |
| 07 . . . 0E | NONCE | 8 bytes of ASCII HEX encoded |
| | | 4 bytes binary data |
| 0F . . . 12 | Session Indicators | 4 bytes of ASCII HEX encoded |
| | | 2 bytes binary data |
| 13 . . . 16 | Control Indicators | 4 bytes of ASCII HEX encoded |
| | | 2 bytes binary data |
| 17 . . . 26 | Update Date | 16 bytes of ASCII HEX encoded |
| | creation Time | 8 bytes binary data - represents |
| | | 64 bit unix timestamp |
| 27 . . . 36 | Update MAC | MAC to protect control indicators - |
| | | 16 bytes of ASCII HEX encoded |
| | | 8 bytes binary data |

In embodiments, the updated MAC may be calculated to protect the control indicators. Specifically, The MAC M is determined by calculating a MAC over the 10 bytes of the update data U with the Update MAC Card Key (MCK).

At 924, the contactless card may generate and provide a message to the client device including the client SDK 992. The data in the message may be utilized by the systems discussed herein to perform the function requested. One example of the message is illustrated and discussed in FIG. 10, message 1000.

At 926, the client including the client SDK 992 may send a message and information to the switchboard system 800. The message may be the message received from the contactless card 102, e.g., message 1000. In addition, the client SDK 992 may send the consent date, the TOS version, and the signed session token to the switchboard system 800. The switchboard system 800 may utilize the information to ensure that the session is valid. At 928, the switchboard system 800 verifies the signed session token is valid, e.g., is the previously provided signed session token and includes the nonce previously generated and is in the message.

In some embodiments, the switchboard system 800 is configured to determine which issuer system or client server it should route the message to for processing. At 930, the switchboard system 800 may determine the issuer ID by extracting it from the message received from the contactless card 102 via the client SDK 992. As mentioned, the issuer ID identifies the issuer of the contactless card 102.

As illustrated in FIG. 9B, in embodiments, the switchboard system 800 is configured to generate and communicate secure communications with the issuer system, e.g., the client server 984 and the validator 988. At 932, the switchboard system 800 sends a request for a key to the client server 984. The key may be utilized to perform the secure communications. In one example, the key request may be an elliptical curve Diffie-Hellman (ECDH) key request. Embodiments are not limited in this manner and alternative key protocols may be utilized, e.g., Supersingular isogeny Diffie-Hellman key exchange (SIDH or SIKE), a private/public key pairing (RSA), etc.

At 934, the client server 984 generates a portion of the key. In some instances, the client server 984 may generate half of the ECDH key for encryption/decryption of PII. Specifically, the client server 984 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 936, the client server 984 stores the generated portion of the key in a storage. Specifically, the client server 984 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 984 may return the public key portion to the switchboard system 800 with the KEY ID at 938. The switchboard system 800 may store the public key portion with the KEY ID for later use, e.g., generation of the ECDH key. At 940, the switchboard system 108 may request a validation to be performed by the validator 988. In one example, the switchboard system 108 may send a request validation as Request validation <MESSAGE>, <SIGNED SESSION TOKEN>, <CLIENT EC PUBLIC KEY>, <CONSENT DATE>, and the <TOS VERSION>. The validator 988 may make an out-of-band request back to the switchboard system 108 for the public key to verify the session at 942. At 944, the switchboard system 800 may provide the node's public key, i.e., <NODE PUBLIC KEY>. Further and at 946, the validator 988 may utilize the node's public key to verify the secure session token.

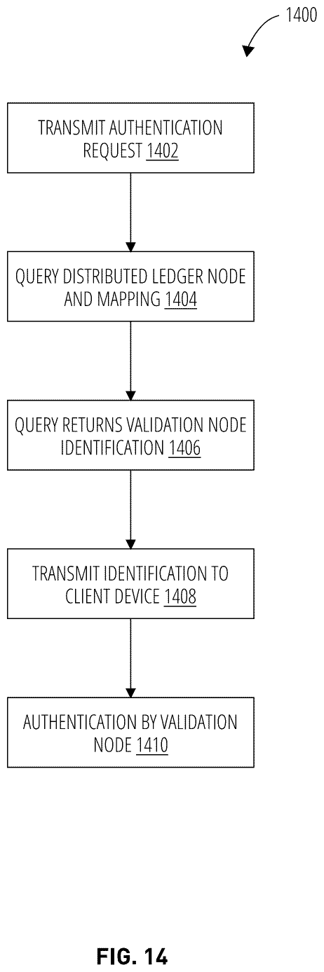

In embodiments, the validator 988 may validate the message at 948. In embodiments, the validator 988 may perform a number of validations including ensure the nonce in the message is correct along with additional information, such as the card's unique identifier (pUID), and the counter value (pATC). FIG. 14 and FIG. 14 discuss additional details of a validation process that may be performed.

At 950, the validator 988 may store information associated with the session. For example, validator 988 may store the <CONSENT DATE> with the <TOS VERSION> and the <PUID>. The validator 988 may also generate another portion of the key, e.g., the ECDH key. For example, the validator 988 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 954, the validator 988 may generate the complete ECDH key. For example, the validator 988 generates the <ECDH KEY> from <ISSUER EC PRIVATE KEY> and <CLIENT EC PUBLIC KEY>. The ECDH KEY is the final key generated using ECDH key negotiation.

The validator 988 may utilize the ECDH KEY to encrypt data for the function. For example, and in some instances, if the validator 988 validates the message, the validator 988 may execute a function request to create a function result and encrypts the result with the ECDH KEY at 956. For example, the validator 988 may Execute <FUNCTION REQUEST> to create <FUNCTION RESULT> and encrypt it with the <ECDH KEY>. The function result may be any result based on the requested function, e.g., verification of the card or user account associated therewith, or sending instructions to a server to communicate with the access control system as described herein.

At 958, the validator 988 may return the function result to the switchboard system 800. In some instances, the function result is returned encrypted. For example, the validator 988 may return the <ENCRYPTED FUNCTION RESULT> and the <ISSUER EC PUBLIC KEY>.

As illustrated in FIG. 9C, in embodiments, the switchboard system 800 sends the function result to the client server 984 to process the result. In one example, the switchboard system 800 may send the <ENCRYPTED FUNCTION RESULT>, <KEY ID>, <ISSUER EC PUBLIC KEY>, and <SIGNED SESSION TOKEN>. At 962 and 964, the client server 984 may make a request for and receive the public key from the switchboard system 800. In some instances, the exchanged may be performed via out-of-band communication channels. The public key for the node may be <NODE PUBLIC KEY>. The public key may be used to verify the sender of the function result, etc. At 966, the 984 may verify the signed session key with the node's public key <NODE PUBLIC KEY> to verify the sender of the information. At 968, the client server 984 may extract client information from the signed session token. For example, the client server 984 may Extract <CLIENT SESSION INFO> from <SIGNED SESSION TOKEN>, i.e., extracting the client implementation-specific user session identification information.

Further and at 970, the client server 984 may retrieve the client private key with the KEY ID. Specifically, the client server 984 may get and remove the <CLIENT PRIVATE KEY> from cache using the <KEY ID>. At 972, the client server 984 may generate or compute the ECDH key. For example, the client server 984 may compute the <ECDH KEY> with the <CLIENT PRIVATE KEY>+<ISSUER EC PUBLIC KEY>. The client server 984 may decrypt the function result with the computed key at 974. Specifically, the client server 984 may decrypt the <ENCRYPTED FUNCTION RESULT> with the <ECDH KEY> to determine the <FUNCTION RESULT>. At 976, the client server 984 associates the function result with the session.

In embodiments, the switchboard system 800 may return that the function result was successfully completed or not at 978 to the client SDK 992. Further and at 980, the client SDK 992 may notify the client app 990 of the result. At 982, the client app 990 may utilize the feature. For example, the client app 990 may communicate with the client server 984 to continue the feature using the <CLIENT SESSION INFO> to fetch the redacted <FUNCTION RESULT>.

FIG. 10 illustrates an example of a message 1000 that may be communicated by a contactless card to perform the functions described herein, such as those discussed in FIG. 9A through FIG. 9C. One or more of the fields in message 1000 may also be utilized to route the message 1000 through the switchboard system and perform authentication/validation techniques.

In embodiments, the message 1000 includes an applet version 1002 field, an issuer discretionary indicator 1004 field, an Issuer Identifier 1006 field, a pKey ID 1008 field, a pUID 1010 field, a pATC 1012 field, a nonce 1014 field, and an encrypted cryptogram 1016.

In embodiments, the fields may be in plain text or encrypted. For example, the applet version 1002 field may include an applet version in plain text. The applet version indicates which applet version is installed on a contactless card and may be used by the other systems to determine how to process the message 1000 when communicated. For example, different Applet versions require different validation logic, e.g., an older message may be routed through the issuer system to perform various operations for validation, while a newer message may be routed through the switchboard system to perform the various operations, including validation.

In embodiments, the message 1000 includes an issuer discretionary indicator 1004 field that may include issuer data and set at the time of personalization. In addition, the message 1000 includes an Issuer Identifier 1006 field that may include a unique ID assigned to the entity issuing the card, e.g., the issuer. For example, when joining the system, each issuer may be assigned a unique identifier during an onboarding operation. The issuer ID can be used by the switchboard system 408 to route a message and its contents to the appropriate services that are associated with that particular issuer.

In embodiments, the message 1000 includes a pKey ID 1008 field. In some instances, the pKey ID 1008 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 402 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described below.

The message 1000 may include a pUID 1010 field, including a card unique identifier assigned to the contactless card at personalization time. The pUID 1010 field data may be a combination of alphanumeric characters used to identify each card and associated with a user uniquely.

In embodiments, the message 1000 includes a pATC 1012 field configured to hold a counter value. The counter value keeps a count of reads (taps) made on the contactless card in a hexadecimal format in one example. Further, a counter value may generate session keys to encrypt at least a portion of a message.

In embodiments, each time a message 1000 is created, a new session key is derived and utilized to generate one or more portions of the message 1000. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1000 is static and set on the card during personalization, and other data is dynamic and may be generated by the card during an operation, e.g., when a read operation is being performed. Note that in some instances, the static information may be updateable, but it may require the customer and card to go through a secure update process, which may be controlled by the issuer.

In embodiments, the contactless card 102 may communicate a message between a device, such as a mobile device, during a read operation. For example, in response to the contactless card 402 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card stores the generated application key(s) or UDK(s).

In embodiments, the contactless card utilizes the application key(s) or UDK(s) to generate session keys for each encrypted data is generated. The following is one processing flow that may be performed by the contactless to generate a unique cryptogram session key (ASK).

To generate the ASK, the contactless card computes SKL by encrypting [ATC[2]∥ATC[3]∥‘F0’∥‘00’∥[ATC[0]∥[ATC[1]∥[ATC[2]∥[ATC[3]] with an application key. Further, the contactless card computes SKR by encrypting [ATC[2]∥ATC[3]∥‘0F’∥‘00’∥[ATC[0]∥[ATC[1]∥[ATC[2]∥[ATC[3]] with the application key. Finally, the contactless card concatenates SKL with SKR to form an authentication session key (ASK). In embodiments, the ASK is used to perform operations utilizing the contactless card, such as encrypting the cryptographic MAC.

In embodiments, the contactless card also supports session key derivation to generate a unique encipherment session key DESK. The contactless card computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card computes SKR by encrypting [ATC[2]∥ATC[3]∥‘0F’∥‘00’∥‘00∥‘00’∥‘00’∥‘00’] with the DEK or UDK. The contactless card concatenates SKL with SKR to form the Data Encipherment Session Key (DESK).

In embodiments, the contactless card generates encrypted data or a cryptogram utilizing the session keys. Specifically, the contactless card generates a cryptogram C by calculating a MAC over the 32-byte transaction data T using the Authentication Session Key (ASK).

The contactless card may process the data to generate the cryptogram. Specifically, the contactless card divides T into four blocks of 8 bytes of data: T=T1∥T2∥T3∥T4. The contactless card computes B=DES(ASKL) [T1], where the Data Encryption Standard or another symmetric encryption algorithm, ASKL is a portion of the ASK, e.g., the “left” half of the key. The contactless card computes B=[B XOR T2], and, the contactless card computes B=DES(ASKL) [B], where DES is an encryption algorithm. The contactless card computes B=[B XOR T3], and the contactless card computes B=DES(ASKL) [B]. The contactless card computes B=[B XOR T4], and the contactless card computes B=DES(ASKL) [B]. The contactless card computes B=DES-1 (ASKR) [B], where DES-1 is the reciprocal DES operation, and ASKR is a portion of the ASK, e.g., the right half. The contactless card computes the cryptogram C=DES(ASKL) [B].

In embodiments, a contactless card may also encipher the cryptogram to secure the data further. For example, a contactless card may generate an 8-byte random number [RND] and the card computes E1=DES3(DESK) [RND], where DES3 is a symmetric encryption algorithm such as the Triple Data Encryption Standard. The contactless card then computes B=[E1] XOR [C], where C is the cryptogram generated, as discussed above. The contactless card computes E2=DES3(DESK) [B], where B is computed above. Further, the contactless card generates the 16-byte enciphered payload E=[E1]∥[E2].

In embodiments, a device or the contactless card may decrypt the payload E by determining, receiving, or retrieving the payload E. The device computes a RND=DES3-1(DESK) [E1]. The device determines B=DES3-1(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U1∥U2. Further, operations may be performed on U1 and U2.

Embodiments include applying an algorithm to the first portion (U1) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U2).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

The encrypted data sent by the contactless card 102 to the mobile device 104 is generated based on one or more cryptographic algorithms described above and the cryptogram session key (ASK) and unique encipherment session key (DESK). The ASK and DESK are stored in a memory of the contactless card 102 and generated based on the unique card key (UDK) and the counter value stored in the memory of the contactless card 102.

FIG. 11 illustrates a diagram of a system 1100 configured to implement one or more embodiments of the present disclosure. More specifically, FIG. 11 details an example embodiment of circuitry within the contactless card 102 from FIG. 1 generating the encrypted data or authorization code. As explained below, during the contactless card 102 creation process, also referred to as personalization, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1102, 1126 may be required for each part of the portfolio on which the one or more applets is issued. For example, the first master key 1102 may comprise an Issuer Cryptogram Generation/Authentication Key (Iss-Key-Auth) and the second master key 1126 may comprise an Issuer Data Encryption Key (Iss-Key-DEK). As further explained herein, two issuer master keys 1102, 1126 are diversified into card master keys 1108, 1120, which are unique for each card. In some examples, a network profile record ID (pNPR) and derivation key index (pDKI) 1122, as back office data, may be used to identify which Issuer Master Keys 1102, 1126 to use in the cryptographic processes for authentication. The system performing the authentication may be configured to retrieve values of pNPR 1122 and pDKI 1124 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1108 and Card-Key-Dek 1120). The session keys (Aut-Session-Key 1132 and DEK-Session-Key 1110) may be generated by the one or more applets and derived by using the application transaction counter (pATC) 1104 with one or more algorithms. To fit data into the one or more algorithms, only the 2 low order bytes of the 4-byte pATC 1104 are used. In some examples, the four byte session key derivation method may comprise: F1:=PATC (lower 2 bytes)∥‘F0’∥‘00’∥PATC (four bytes) F1:=PATC (lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 1104 counter. At each tap of the contactless card, pATC 1104 is configured to be updated, and the card master keys Card-Key-AUTH 1108 and Card-Key-DEK 1120 are further diversified into the session keys Aut-Session-Key 1132 and DEK-Session-KEY 1110. pATC 1104 may be initialized to zero at personalization or applet initialization time. In some examples, the pATC counter 1104 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication code may be delivered as the content of a text NDEF record in hexadecimal ASCII format. In some examples, only the authentication code and an 8-byte random number followed by MAC of the authentication code may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1132. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1132, as explained above. As explained above, the low order two bytes of the counter may be used to diversify for the one or more MAC session keys. As explained below, AUT-Session-Key 1132 may be used to MAC data 1106, and the resulting data or cryptogram An 1114 and random number RND may be encrypted using DEK-Session-Key 1110 to create cryptogram B or output 1118 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1110 derived from the Card-Key-DEK 1120. In this case, the ATC value for the session key derivation is the least significant byte of the counter pATC 1104.

The format below represents a binary version example embodiment. Further, in some examples, the first byte may be set to ASCII ‘A’.

Message Format

| | | | | |
|---|---|---|---|---|
| 1 | 2 | 4 | 8 | 8 |
| 0x43 (Message Type ‘A’) | Version | pATC | RND | Cryptogram A (MAC) |

| | |
|---|---|
| Cryptogram A (MAC) | 8 bytes |

MAC of

| | | | | |
|---|---|---|---|---|
| 2 | 8 | 4 | 4 | 18 bytes input data |
| Version | pUID | pATC | Shared Secret | |

Message Format

| | | | |
|---|---|---|---|
| 1 | 2 | 4 | 16 |
| 0x43 (Message Type ‘A’) | Version | pATC | Cryptogram B |
| Cryptogram A (MAC) | 8 bytes | | |

MAC of

| | | | | |
|---|---|---|---|---|
| 2 | 8 | 4 | 4 | 18 bytes input data |
| Version | pUID | pATC | Shared Secret | |

| Cryptogram B | 16 |
|---|---|
| Sym Encryption of | |
| 8 | 8 |
| RND | Cryptogram A |

Another exemplary format is shown below. In this example, the tag may be encoded in hexadecimal format.

Message Format

| | | | | |
|---|---|---|---|---|
| 2 | 8 | 4 | 8 | 8 |
| Version | pUID | pATC | RND | Cryptogram A (MAC) |

8 bytes

| | | | | |
|---|---|---|---|---|
| 8 | 8 | 4 | 4 | 18 bytes input data |
| pUID | pUID | pATC | Shared Secret | |

Message Format

| 2 | 8 | 4 | 16 |
|---|---|---|---|
| Version | pUID | pATC | Cryptogram B |
| 8 bytes | | | |

| 8 | | 4 | 4 | 18 bytes input data |
|---|---|---|---|---|
| pUID | pUID | pATC | Shared Secret | |

| Cryptogram B | 16 |
|---|---|
| Sym Encryption of | |
| 8 | 8 |
| RND | Cryptogram A |

The UID field of the received message may be extracted to derive, from master keys Iss-Key-AUTH 1102 and Iss-Key-DEK 1126, the card master keys (Card-Key-Auth 1108 and Card-Key-DEK 1120) for that particular card. Using the card master keys (Card-Key-Auth 1108 and Card-Key-DEK 1120), the counter (pATC) 1104 field of the received message may be used to derive the session keys (Aut-Session-Key 1132 and DEK-Session-Key 1110) for that particular card. Cryptogram B 1118 may be decrypted using the DEK-Session-KEY 1110, which yields cryptogram An 1114 and RND, and RND may be discarded. The UID field may be used to look up the shared secret of the contactless card which, along with the Ver, UID, and pATC fields of the message, may be processed through the cryptographic MAC using the re-created Aut-Session-Key 1132 to create a MAC output, such as MAC′. If MAC′ is the same as cryptogram An 1114, then this indicates that the message decryption and MAC checking have all passed. Then the pATC 1104 may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1132. The input data 1106 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) 1104 as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1112, data 1106 is processed through the MAC using Aut-Session-Key 1132 to produce MAC output (cryptogram A) 1114, which is encrypted.

In order to provide additional protection against brute force attacks exposing the keys on the card, it is desirable that the MAC cryptogram 1114 be enciphered. In some examples, data or cryptogram An 1114 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1110. In the encryption operation 1116, data or cryptogram An 1114 and RND are processed using DEK-Session-Key 1110 to produce encrypted data, cryptogram B 1118. The data 1114 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

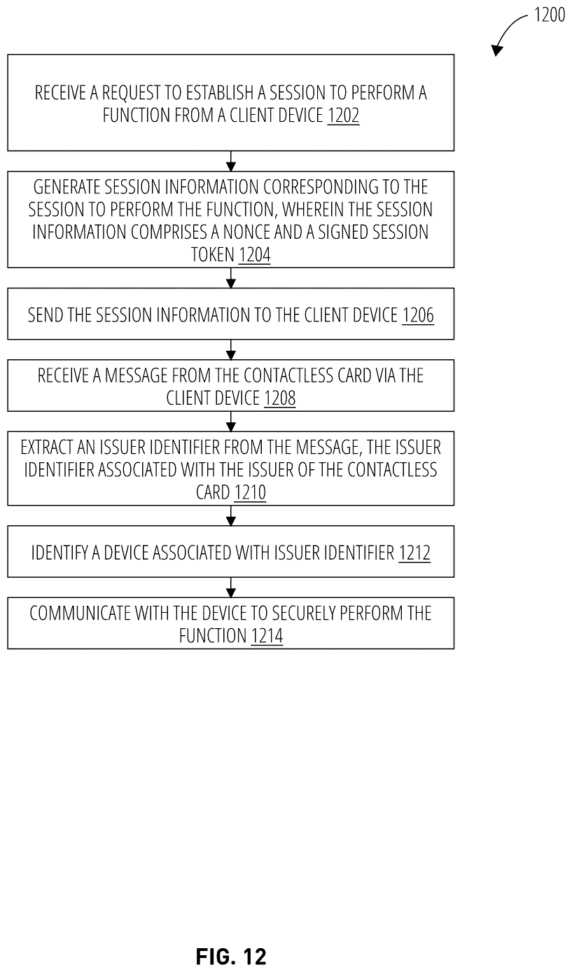

FIG. 12 illustrates an example of routine 1200 in accordance with embodiments discussed herein. In block 1202, the routine 1200 includes receiving, by a node in a system, a request to establish a session to perform a function from a client device, wherein the function is at least partially performed utilizing a contactless card. The function being performed may include altering the state of the access control system 110 described above with respect to FIG. 1. In some instances, the node may be one of a plurality nodes of a switchboard system from FIG. 8. The node may be previously selected by the sending device via a DNS operation performed.

In block 1204, the routine 1200 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1206, routine 1200 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 11).

In block 1208, routine 1200 includes receiving, by the node, a message from the contactless card via the client device. The message may be generated by the contactless card. FIG. 11 illustrates one example of a message 1100. In some embodiments, the node verifies the message. For example, the node may verify a nonce in the message and a signed session token.

In block 1210, routine 1200 extracts an issuer identifier from the message by the node, the issuer identifier associated with the issuer of the contactless card. In some instances, the issuer identifier may be in a plaintext format.

In block 1212, routine 1200 identifies, by the node, a device associated with the issuer identifier. For example, the node may perform a lookup to determine a server associated with the issuer identifier and the function to be performed.

In block 1214, routine 1200 communicates, by the node, with the device to securely perform the function.

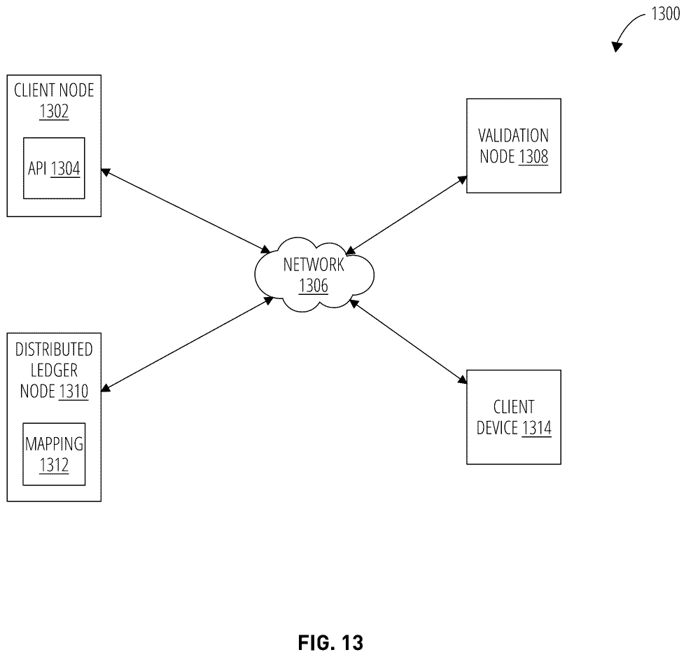

FIG. 13 illustrates a distributed network authentication system 1300 according to an example embodiment. As further discussed below, system 1300 can include client node 1302, API 1304, network 1306, distributed ledger node 1310, mapping 1312, and client device 1314. Although FIG. 13 illustrates single instances of the components, system 1300 can include any number of components. System 1300

System 1300 can include a client node 1302, which can be a network-enabled computer as described herein. In some examples, client node 1302 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, client node 1302 can execute one or more applications, such as software applications, that enable, for example, network communications with one or more components of system 1300, transmit and/or receive data, and perform the functions and processes described herein.

The client node can contain an API 1304. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1304 to interact with the service, such as by performing a remote call to an API for interacting with a web-based service.

API 1304 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1302 can communicate with one or more other components of system 1300 either directly or via network 1306. Network 1306 can comprise one or more of a wireless network, a wired network or any combination of wireless network and wired network, and may be configured to connect the components of system 1300. While FIG. 13 illustrates communication between the components of system 1300 through network 1306, it is understood that any component of system 1300 can communicate directly with another component of system 1300, e.g., without involving network 1306.

System 1300 can include a validation node 1308, which can be a network-enabled computer as described herein. In some examples, validation node 1308 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, validation node 1308 can execute one or more applications, such as software applications, that enable, for example, network communications with one or more components of system 1300, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1300 can include a distributed ledger node 1310, which can be a network-enabled computer as described herein. In some examples, distributed ledger node 1310 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, distributed ledger node 1310 can execute one or more applications, such as software applications, that enable, for example, network communications with one or more components of system 1300, transmit and/or receive data, and perform the functions and processes described herein.

Distributed ledger node 1310 can containing a mapping 1312. In some examples, mapping 1312 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1300, or the one or more databases can be hosted externally to any component of the system 1300. In some examples, the one or more databases can be contained in the distributed ledger node 1310, and in other examples the one or more databases can be stored outside of distributed edger node 1310 but in data communication with distributed ledger node 1310. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1310. In other examples, the one or more databases can be remote from distributed ledger node 1310 but in data communication with distributed ledger node 1310. Data communication between the one or more databases and distributed ledger node 1310 can be a direct data communication or data communication via a network, such as the network 1306.

In some examples, client node 1302 can be in data communication with distributed ledger node 1310. Distributed ledger node 1310 can contain mapping 1312. Mapping 1314 may include, e.g., a mapping between a validation node address and the validation node 1308, a mapping between a routing number and a validation node address, and/or a mapping between a routing number and validation node 1308. In some examples, mapping 1312 can include a digital signature associated with an entity having permission to validate for a routing number. Based on one or more of these associations, client node 1302 can call validation node for validation and/or provide direction to the client device to reach the appropriate validation node. This can be accomplished by calling a validation API associated with validation node 1308.

In some examples, iterations of the mappings described herein, such as mapping 1312, can also include a software or applet version number. The version number can be used to identify a validation node or validation node address or choose between multiple validation addresses for one validation node.

In some examples, client node 1302 and distributed ledger node 1310 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1310 can update mapping 1312 to reflect a different association between, e.g., a routing number, a validation node address, and a validation node. In some examples, degrees of permissions can be issued. For example, if client node 1302 were to function to route data to validation node 1308 (or other validation nodes), client node 1302 can be given a certain level of permissions. As another example, if distributed ledger node 1310 were to have the capability to update mapping 1312, distributed ledger node 1310 can have a different, higher level of permissions.

System 1300 can include a client device 1314, which can be a network-enabled computer as described herein. In some examples, distributed ledger node 1314 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300. Client device 1314 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1314 can be in data communication with another network-enabled computer not shown in FIG. 13, such as a smart card (e.g., a contactless card or a contact-based card).

In some examples, client device 1314 can execute one or more applications, such as software applications, that enable, for example, network communications with one or more components of system 1300, transmit and/or receive data, and perform the functions and processes described herein.

In some examples, upon receipt of an authentication request, client device 1314 can call (e.g., via an API) client node 1302. The call can include a routing number and/or an applet or software version number, and client node 1302 can query distributed ledger node 1310 and mapping 1312. Once the query returns the identification of a validation node (e.g., validation node 1308) and/or a validation node address associated with that routing number and/or applet or software version, client node 1302 can reply to client device 1314. Client device 1314 can then proceed with authentication with the validation node. The authentication can be performed by, e.g., the systems and methods described herein, such as by the generation, encryption, transmission, decryption, and validation of a cryptogram as described herein.

In some examples, client node 1302 can be co-resident with validation node 1308. In these examples, client node 1302 can handle the authentication in a single call from client device 1314. In some examples, this can be acceptable only if it is permissible for the full authentication transmission (e.g., a cryptogram as described herein) to be sent to client nodes that are not involved in authentication.

In some examples, if client node 1302 receives, from client device 1314, a routing number that is not handled by its location, client node 1302 can return a code indicating that this routing number is not handled, along with validation node address for the responsible validation node. Client device 1314 can then send the full authentication transmission to validation node 1308 using the received validation node address.

In some examples, client node 1302 can enter the distributed network with different permissions. For example, client node 1302 can be a read-only router of data. As another example, client node 1302 can have permission to send messages to distributed ledger node 1310 updating one or more routing paths for one or more routing numbers. However, client node 1302 would be prevented from updating one or more routing paths for one or more routing numbers for other entities that control other routing numbers which are not associated with client node 1302 or that did not grant this permission. As another example, distributed ledger node 1310 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1302, distributed ledger node 1310, and/or validation node 1308, if security, legal, and/or financial conditions are met, however, delegation is not required.

In some examples, one or more APIs can facilitate communication between components of system 1300 via network 1306. In other examples, one or more APIs are not required. Rather, the components of system 1300 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1308 for authentication, can require storage of the keys in one or more HSMs, to promote key security and ensure that the keys are never entered into memory.

FIG. 14 illustrates a method 1400 performed by a distributed network authentication system, such as system 1300 from FIG. 13, according to an example embodiment. For example, the method can be performed by distributed network authentication system 1300 and or by another distributed network authentication system.

In block 1402, a client device can transmit an authentication request to a client node. The authentication request can include, without limitation, a routing number, a software version number, and/or an applet version number. The request can be made by an API call or other communication between the client device and the client node.

In block 1404, after receiving the authentication request, the client node can transmit a query (e.g., via an API call) to a distributed ledger node. The distributed ledger node contain a mapping, and the distributed ledger node can submit the query to the mapping.

In block 1406, the query can return an identification of a validation node and/or a validation node address, and the distributed ledger node can transmit this identification to the client node.

In block 1408, the client node can transmit the identification to the client device. After receiving the identification, the client device can proceed with authentication with the identified validation node and/or validation node address, in block 1410.

The various elements of the devices as previously described with reference to FIGS. 1-24 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method comprising:
receiving, by an application executing on a processor circuit of a mobile device, encrypted data from a communications interface of a contactless card associated with a user account;
determining, based on the encrypted data, whether the user account is authorized to alter a state of an access control system;
determining, by the mobile device, a geographic location thereof; and
in response to the user account being authorized to alter the state of the access control system and the geographic location of the mobile device being located within a predefined distance of the access control system, transmitting, by the mobile device, a control signal directly to a control circuit of the access control system to thereby alter the state of the access control system.

2. The method of claim 1, wherein determining whether the user account is authorized to alter the state of the access control system comprises transmitting, by the mobile device, the encrypted data to an authentication system associated with the user account.

3. The method of claim 2, wherein the method further comprises:
comparing, by the authentication system, the encrypted data to a list of authorized user accounts and their corresponding expected encrypted data;
determining that the encrypted data matches the corresponding expected encrypted data for the user account; and
transmitting an authorization message to the mobile device indicating that the user account is authorized to alter the state of the access control system.

4. The method of claim 3, wherein the method further comprises in response to the mobile device receiving the authorization message and the mobile device confirming that the geographic location of the mobile device is within the predefined distance of the access control system, transmitting, by the mobile device, the control signal to the access control system to alter the state of the access control system.

5. (canceled)

6. (canceled)

7. The method of claim 1, wherein the encrypted data is generated based on one or more cryptographic algorithms and a cryptogram session key (ASK) and unique encipherment session key (DESK), the ASK and DESK stored in a memory of the contactless card and generated based on a unique card key (UDK) and a counter value stored in the memory of the contactless card; and
wherein the access control system comprises one or more of the following:
an electronic door lock, or control circuit thereof;
a garage door control circuit;
a locker control circuit;
an automobile door or trunk control circuit; and
a manufacturing facility control circuit, and
wherein altering the state of the access control system includes activating, deactivating, unlocking, locking, or altering a system setting of the access control system, including a control circuit thereof.

8. An apparatus comprising:
memory to store instructions thereon;
a processor circuit to execute the instructions, wherein in response to executing the instructions, the processor circuit is caused to:
receive an authentication code from a communications interface of a contactless card associated with a user account, the user account also being associated with a computer application executing on the apparatus;
determine, based on the authentication code, whether the user account is authorized to alter a state of an access control system;
determine a geographic location of the apparatus; and
in response to the user account being authorized to alter the state of the access control system and the geographic location of the apparatus being located within a predefined distance of the access control system, transmitting, by the mobile device, a control signal directly to a control circuit of the access control system to thereby alter the state of the access control system.

9. The apparatus of claim 8, wherein to determine whether the user account is authorized to alter the state of the access control system, the processor circuit is further to send the authentication code to an authentication system associated with the user account.

10. The apparatus of claim 9, wherein the processor circuit is further to:
receive an authorization message from the authentication system indicating that the user account is authorized to alter the state of the access control system.

11. (canceled)

12. (canceled)

13. (canceled)

14. The apparatus of claim 8, wherein the access control system comprises one or more of the following:
an electronic door lock, or control circuit thereof;
a garage door control circuit;
a locker control circuit;
an automobile door or trunk control circuit; and
a manufacturing facility control circuit, and
wherein the control signal includes at least one instruction to activate, deactivate, unlock, lock, or alter a system setting of the access control system, including a control circuit thereof.

15. A non-transitory computer-readable storage medium having computer-readable instructions embodied therewith, the computer-readable instructions executable by a processor circuit to cause the processor circuit to:
receive encrypted data from a communications interface of a contactless card associated with a user account;
determine, based on the encrypted data, whether the user account is authorized to alter a state of an access control system;
determine a geographic location thereof; and
in response to the user account being authorized to alter the state of the access control system and the geographic location of the mobile device being located within a predefined distance of the access control system, transmitting, by the mobile device, a control signal directly to a control circuit of access control system to thereby alter the state of the access control system.

16. The non-transitory computer-readable storage medium of claim 15, wherein the processor circuit to determine whether the user account is authorized to alter a state of the access control system comprises:
the processor circuit to:
send the encrypted data to an authentication system associated with the user account; and
receive, from the authentication system, an authorization message indicating that the user account is authorized to alter the state of the control system; or
the processor circuit to:
compare the encrypted data to a list of authorized user accounts and their corresponding expected encrypted data;
determine that the encrypted data matches the corresponding expected encrypted data for the user account, and thereby confirm that the user account is authorized to alter the state of the access control system.

17. The non-transitory computer-readable storage medium of claim 16, wherein the processor circuit is further, in response to the processor circuit receiving the authorization message or confirming that the user account is authorized to alter the state of the access control system, to:
confirm that the geographic location of the processor circuit is within the predefined distance of the access control system; and
transmit the control signal to the access control system to alter the state of the access control system.

18. The non-transitory computer-readable storage medium of claim 16, wherein the processor circuit is further, in response to the processor circuit receiving the authorization message or confirming that the user account is authorized to alter the state of the access control system, to:
confirm that the geographic location of the processor circuit is within the predefined distance of the access control system; and
transmit a message to a separate computing device in communication with the access control system, the message including instructions to cause the separate computing device to send the control signal to a control circuit of the access control system to alter the state thereof.

19. The non-transitory computer-readable storage medium of claim 15, wherein the encrypted data is generated based on one or more cryptographic algorithms and a cryptogram session key (ASK) and unique encipherment session key (DESK), the ASK and DESK stored in a memory of the contactless card and generated based on a unique card key (UDK) and a counter value stored in the memory of the contactless card.

20. The non-transitory computer-readable storage medium of claim 15, wherein the access control system comprises one or more of the following:
an electronic door lock, or control circuit thereof;
a garage door control circuit;
a locker control circuit;
an automobile door or trunk control circuit; and
a manufacturing facility control circuit, and
wherein the control signal includes at least one instruction to activate, deactivate, unlock, lock, or alter a system setting of the access control system, including a control circuit thereof.

21. The method of claim 1, wherein the communications interface of the contactless card comprises a Near Field Communication (NFC) interface, and wherein receiving the encrypted data occurs in response to the contactless card being tapped against the mobile device.

22. The method of claim 1, wherein the control signal is transmitted directly to the control circuit of the access control system via a Bluetooth Low Energy (BLE) communication protocol.

23. The method of claim 1, further comprising:
receiving, by the mobile device from the control circuit, a confirmation message indicating that the state of the access control system has been successfully altered; and
outputting, by the mobile device, at least one of a visual notification or a haptic feedback corresponding to the confirmation message.

24. The method of claim 1, wherein determining the geographic location of the mobile device relative to the access control system comprises determining a value from a BLE signal to confirm the mobile device is within the predefined distance.
